(19) United States
(12) Patent Application Publication
(10) Pub. No.: US 2026/0080507 A1
(43) Pub. Date: Mar. 19, 2026

(54) IMAGE PROCESSING FOR FOVEATED IMAGING

(71) Applicant: QUALCOMM Incorporated, San Diego, CA (US)

(72) Inventors: Aakil Mahendra BAPNA, Bangalore (IN); Abhijeet DEY, Bengaluru (IN); Amrit Anand AMRESH, Bangalore (IN); Shrey Shailesh GADIYA, Bengaluru (IN); Santhosh Reddy MANDHALA, Bangalore (IN); Vijayamanohar NAGARAJAN, Bangalore (IN); Praveen SEKAR, Bangalore (IN); Yashu ARORA, Allahabad (IN); Joby ABRAHAM, Bangalore (IN)

(21) Appl. No.: 18/890,492

(22) Filed: Sep. 19, 2024

(51) Int. Cl. G06T 5/50; G06T 1/20; G06T 5/20; G06T 7/11; G06T 7/90

(52) U.S. Cl. CPC G06T 5/50; G06T 1/20; G06T 5/20; G06T 7/11; G06T 7/90; G06T 2207/20016; G06T 2207/20021

(57) ABSTRACT

Systems and techniques are described for image processing. For example, a computing device can obtain, from an image sensor, a peripheral image frame of a scene, a blend image frame, and a foveated image frame. The peripheral image frame includes the blend image frame and the foveated image frame. The computing device can determine, based on the peripheral image frame, statistics for the peripheral image frame that include a respective pixel value, a respective luma value, and/or a respective chroma value associated with each pixel of a plurality of pixels of the peripheral image frame. The computing device can determine, based on a first starting location within the statistics, a first configuration for the blend image frame and can determine, based on a second starting location within the statistics, a second configuration for the foveated image frame.

### FIELD

The present disclosure generally relates to image processing. For example, aspects of the present disclosure relate to an image signal processor to improve image quality (IQ) and reduce area, power, and double data rate (DDR) bandwidth.

### BACKGROUND

A camera can receive light and capture image frames, such as still images or video frames, using an image sensor. Cameras can be configured with a variety of image-capture settings and/or image-processing settings to alter the appearance of images captured thereby. Image-capture settings may be determined and applied before and/or while an image is captured, such as ISO, exposure time (also referred to as exposure, exposure duration, or shutter speed), aperture size (also referred to as f/stop), focus, and gain (including analog and/or digital gain), among others. Moreover, image-processing settings can be configured for post-processing of an image, such as alterations to contrast, brightness, saturation, sharpness, levels, curves, and colors, among others.

A foveated image is an image with different resolutions in different regions within the image. For example, a foveated image may include a highest resolution in a region of interest (ROI) and lower-resolution regions around the ROI (e.g., in a “peripheral region”).

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described herein for image processing. In some aspects, an apparatus for image processing is provided. The apparatus includes at least one memory and at least one processor coupled to the at least one memory and configured to: obtain, from an image sensor, a peripheral image frame of a scene, a blend image frame, and a foveated image frame, wherein the peripheral image frame includes the blend image frame and the foveated image frame; determine, based on the peripheral image frame, statistics for the peripheral image frame, wherein the statistics include at least one of a respective pixel value, a respective luma value, or a respective chroma value associated with each pixel of a plurality of pixels of the peripheral image frame; determine, based on a first starting location within the statistics, a first configuration for the blend image frame; and determine, based on a second starting location within the statistics, a second configuration for the foveated image frame, wherein the first starting location and the second starting location within the statistics each indicate a respective pixel of the plurality of pixels of the peripheral image frame to start reading the statistics.

In some aspects, a method for image processing at a device is provided. The method includes: obtaining, by an image sensor associated with the device, a peripheral image frame of a scene, a blend image frame, and a foveated image frame, wherein the peripheral image frame includes the blend image frame and the foveated image frame; determining, based on the peripheral image frame, statistics for the peripheral image frame, wherein the statistics include at least one of a respective pixel value, a respective luma value, or a respective chroma value associated with each pixel of a plurality of pixels of the peripheral image frame; determining, based on a first starting location within the statistics, a first configuration for the blend image frame; and determining, based on a second starting location within the statistics, a second configuration for the foveated image frame, wherein the first starting location and the second starting location within the statistics each indicate a respective pixel of the plurality of pixels of the peripheral image frame to start reading the statistics.

A non-transitory computer-readable medium having stored thereon instructions that, when executed by at least one processor, cause the at least one processor to: obtain, from an image sensor, a peripheral image frame of a scene, a blend image frame, and a foveated image frame, wherein the peripheral image frame includes the blend image frame and the foveated image frame; determine, based on the peripheral image frame, statistics for the peripheral image frame, wherein the statistics include at least one of a respective pixel value, a respective luma value, or a respective chroma value associated with each pixel of a plurality of pixels of the peripheral image frame; determine, based on a first starting location within the statistics, a first configuration for the blend image frame; and determine, based on a second starting location within the statistics, a second configuration for the foveated image frame, wherein the first starting location and the second starting location within the statistics each indicate a respective pixel of the plurality of pixels of the peripheral image frame to start reading the statistics.

In some aspects, an apparatus for image processing is provided. The apparatus includes: means for obtaining, by an image sensor associated with the device, a peripheral image frame of a scene, a blend image frame, and a foveated image frame, wherein the peripheral image frame includes the blend image frame and the foveated image frame; means for determining, based on the peripheral image frame, statistics for the peripheral image frame, wherein the statistics include at least one of a respective pixel value, a respective luma value, or a respective chroma value associated with each pixel of a plurality of pixels of the peripheral image frame; means for determining, based on a first starting location within the statistics, a first configuration for the blend image frame; and means for determining, based on a second starting location within the statistics, a second configuration for the foveated image frame, wherein the first starting location and the second starting location within the statistics each indicate a respective pixel of the plurality of pixels of the peripheral image frame to start reading the statistics.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a diagram illustrating an example extended-reality (XR) system, in accordance with some aspects of the disclosure.

FIG. 2A is an illustration of a first view of a head-mounted device (HMD), in accordance with some aspects of the disclosure.

FIG. 2B is an illustration of a second view of the HMD of FIG. 2A, in accordance with some aspects of the disclosure.

FIG. 2C is an illustration of example images of eyes of a user of the HMD of FIG. 2A, in accordance with some aspects of the disclosure.

FIG. 3 is an illustration illustrating an example foveated image, in accordance with some aspects of the disclosure.

FIG. 4 illustrates an example implementation of a system-on-a-chip (SOC), in accordance with some aspects of the disclosure.

FIG. 5 is a block diagram illustrating an example architecture of an image capture and processing system, in accordance with some aspects of the disclosure.

FIG. 6 is a diagram illustrating an example of an image frame including a peripheral region, a blend region, and a foveated region, in accordance with some aspects of the disclosure.

FIG. 7 is a diagram illustrating an example of a multi-context architecture including an inline front end (IFE) with multi-context modules, in accordance with some aspects of the disclosure.

FIG. 8 is a diagram illustrating an example of a module, which may be employed for the IFE of FIG. 7, where the module includes separate registers, lookup tables (LUTs), and processing pipelines for three different contexts, in accordance with some aspects of the disclosure.

FIG. 9 is a diagram illustrating an example of an image frame including a peripheral region, a current foveated region, a next foveated region, a current blend region, and a next blend region, in accordance with some aspects of the disclosure.

FIG. 10 is a diagram illustrating an example of an image frame including the current foveated region and the current blend region, and an example of an image frame including the next foveated region and the next blend region, in accordance with some aspects of the disclosure.

FIG. 11 is a diagram illustrating an example of an image frame resulting from a statistic-based configuration from the current foveated region and the current blend region being applied to the next foveated region and the next blend region, and an example of an image frame resulting from a statistic-based configuration from the next foveated region and the next blend region being applied to the next foveated region and the next blend region, in accordance with some aspects of the disclosure.

FIG. 12 is a diagram illustrating an example of an image frame including a peripheral region, a current blend region, and a current foveated region, where the image frame includes a grid, in accordance with some aspects of the disclosure.

FIG. 13 is a diagram illustrating an example of an image frame including a peripheral region, a next blend region, and a next foveated region, where the image frame includes a grid, in accordance with some aspects of the disclosure.

FIG. 14 is a diagram illustrating an example of the module of FIG. 8 and an example of a module, which may be employed for the IFE of FIG. 18, including a shared LUT and separate registers and processing pipelines for three different contexts, in accordance with some aspects of the disclosure.

FIG. 15 is a diagram illustrating an example of a module, which may be employed for the IFE of FIG. 18, including shared LUT addressing logic, in accordance with some aspects of the disclosure.

FIG. 16 is a diagram illustrating an example of an image frame including example starting locations for a current blend region, a next blend region, a current foveated region, and a next foveated region, in accordance with some aspects of the disclosure.

FIG. 17 is a diagram illustrating an example of a module, which may be employed for the IFE of FIG. 18, including shared LUT addressing logic, in accordance with some aspects of the disclosure.

FIG. 18 is a diagram illustrating an example of an architecture including an IFE with both single-context modules and multi-context modules, in accordance with some aspects of the disclosure.

FIG. 19 is a flow diagram illustrating an example of a process for image processing, in accordance with some aspects of the disclosure.

FIG. 20 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

A foveated image is an image with different resolutions in different regions within the image. For example, a foveated image may include a highest resolution in a region of interest (ROI) and one or more lower-resolution regions around the ROI (e.g., in “peripheral regions”). Some foveated images may include one peripheral region, for example, surrounding the ROI. Other foveated images may include several tiered peripheral regions, for example, a first peripheral region (e.g., a blend region) surrounding the ROI (e.g., the foveated region) and a second peripheral region (e.g., a peripheral region encompassing the entire foveated image) surrounding the first peripheral region (e.g., the blend region).

Some devices may capture, modify, and/or render foveated images based on a gaze of a user. For example, some devices may determine where a viewer is gazing within an image frame and determine an ROI for a foveated image based on the gaze. The device may then capture, modify, and/or render image data (e.g., foveated image data) to have the highest resolution in the ROI and lower resolution outside the ROI (e.g., at “peripheral regions”).

For example, a foveated-image sensor can be configured to capture a first image of an ROI of a field of view in high resolution. The first image may be referred to as a “fovea region” or an “ROI.” The foveated-image sensor may also capture another image of the full field of view at a lower resolution. The portion of the lower-resolution image that is outside the ROI may be referred to as the peripheral region. As another example, a foveated-image image sensor may capture a foveated image in which the ROI as the high resolution and the peripheral region has the lower resolution. Additionally or alternatively, a processor can generate a foveated image including an ROI at a higher resolution and a peripheral region at a lower resolution.

Extended reality (XR) may include virtual reality (VR), augmented reality (AR), and/or mixed reality (MR). Some XR head-mounted devices (HMDs) may implement video see through (VST). In VST, an XR HMD may capture images of a field of view of a user and display the images to the user as if the user were viewing the field of view directly. While displaying the images of the field of view, the XR HMD may alter or augment the images providing the user with an altered or augmented view of the environment of the user (e.g., providing the user with an XR experience).

A foveated image sensor can capture three image frames with different resolutions in an interleaved manner. The images frames captured can include a peripheral image frame that corresponds to a peripheral region, a blend image frame (e.g., with a higher resolution than the peripheral image frame) that corresponds to a blend region, and a foveated image frame (e.g., with a higher resolution than the blend image frame) that corresponds to a foveated region (e.g., an ROI). In foveated sensing systems, statistics (e.g., pixel values, luma values, and/or chroma values) may be based on an initial ROI (e.g., based on an eye gaze) which may change. In existing implementations, statistics for different ROIs may be stored in different registers and may require a delay of one image frame to implement upon a change (e.g., an eye gaze change).

For some cases, such as some XR use cases, a foveated region and a blend region can change per image frame, while a peripheral region may remain relatively stable (e.g., when an eye gaze changes, but there is minimal global motion). These cases are not supported by current image signal processor (ISP) architectures and, as such, image quality (IQ) degradation can occur in the foveated image frame and the blend image frame.

As such, improved systems and techniques for an improved ISP to improve image quality (IQ) for image frames can be beneficial.

In one or more aspects of the present disclosure, systems, apparatuses, methods (also referred to as processes), and computer-readable media (collectively referred to herein as “systems and techniques”) are described herein that provide solutions for an image signal processor to improve IQ as well as to reduce area, power, and double data rate (DDR) bandwidth

Various aspects relate generally to image processing. Some aspects more specifically relate to systems and techniques that provide solutions for a multi-context ISP architecture for a peripheral image frame, a blend image frame, and a foveated image frame. In one or more examples, the systems and techniques employ a single shared lookup table (LUT) that can provide statistics for an entire image frame (e.g., a peripheral image frame including a blend image frame and a foveated image frame) for instant adjustment upon an eye gaze change as compared to determining a new setting requiring a delay of at least one image frame.

In one or more examples, the systems and techniques can ensure the availability of appropriate statistics for foveated and blend regions in an eye gaze change scenario that can improve IQ and ensure tone consistency. In some examples, the systems and techniques provide an architecture for an ISP (e.g., an XR-ISP) that supports both single context statistics collection and multi-context image processing pipeline. In one or more examples, the systems and techniques provide LUT sharing between peripheral, foveated, blend image frames in a multi-context image processing path. In some examples, the systems and techniques provide an area lite solution for an ISP.

In one or more aspects, during operation for image processing, an image sensor, associated with a device, can obtain a peripheral image frame of a scene, a blend image frame, and a foveated image frame. In one or more examples, the peripheral image frame can include the blend image frame and the foveated image frame. One or more processors, associated with the device, can determine, based on the peripheral image frame, statistics for the peripheral image frame. In some examples, the statistics can include a respective pixel value, a respective luma value, and/or a respective chroma value associated with each pixel of a plurality of pixels of the peripheral image frame. The one or more processors can determine, based on a first starting location within the statistics, a first configuration for the blend image frame. The one or more processors can determine, based on a second starting location within the statistics, a second configuration for the foveated image frame. In one or more examples, the first starting location and the second starting location within the statistics can each indicate a respective pixel of the plurality of pixels of the peripheral image frame to start reading the statistics.

In one or more examples, the first configuration can include a respective blend pixel value, a respective blend luma value, or a respective blend chroma value associated with each pixel of a plurality of pixels of the blend image frame. In some examples, the second configuration can include a respective foveated pixel value, a respective foveated luma value, or a respective foveated chroma value associated with each pixel of a plurality of pixels of the foveated image frame.

In some examples, one or more processors can apply the first configuration to the blend image frame. The one or more processors can apply the second configuration to the foveated image frame. In some examples, applying the first configuration to the blend image frame and the second configuration to the foveated image frame can be performed by a shared processing pipeline (e.g., including the one or more processors) associated with the peripheral image frame, the blend image frame, and the foveated image frame. In some examples, determining the statistics for the peripheral image frame can be performed by the shared processing pipeline associated with the peripheral image frame, the blend image frame, and the foveated image frame.

In some examples, a first register, associated with the blend image frame, can determine the first starting location within the statistics. In one or more examples, a second register, associated with the foveated image frame, can determine the second starting location within the statistics. In one or more examples, the statistics can be stored within a shared lookup table (LUT) associated with the peripheral image frame, the blend image frame, and the foveated image frame. In some examples, the statistics stored within the shared LUT can be associated with the peripheral image frame, the blend image frame, and the foveated image frame. In one or more examples, a first LUT address generation logic associated with the blend image frame can update the shared LUT to point to the first starting location within the statistics. In some examples, a second LUT address generation logic associated with the foveated image frame can update the shared LUT to point to the second starting location within the statistics. In one or more examples, the foveated image frame can have a higher resolution than the blend image frame, and the blend image frame can have a higher resolution of the peripheral image frame. In some examples, the image sensor can be a foveated image sensor. In one or more examples, the device can be an extended reality (XR) device.

Particular aspects of the subject matter described in this disclosure can be implemented to realize one or more of the following potential advantages. In one or more examples, the systems and techniques can provide the benefit of image quality improvement. For example, for some use cases (e.g., some XR use cases), foveated and blend regions can change per frame, while the peripheral is relatively stable (e.g., eye gaze changes with minimal global motion). Delay due to statistics collection and computation for foveated and blend image frames can result in IQ and VST degradation. However, the systems and techniques can ensure that correct statistics-based configurations are applied to the respective foveated and blend image frames without any delay.

In one or more examples, the systems and techniques can provide the benefit of a reduction in power. For example, a network on a chip (NOC) and bus associated with a current ISP architecture can only handle transactions for statistics of a single context (e.g., a single region), not three contexts (e.g., three regions). For contexts that are not desired, the systems and techniques can gate the statistics collection modules associated with those context, which can result in a reduction in power consumption.

In some examples, the systems and techniques can provide the benefit of a reduction in area (e.g., chip area). In one or more examples, the systems and techniques allow for reading a configuration (e.g., based on statistics) from a single LUT, which can save on LUT area. The systems and techniques allow for outputting statistics for only the peripheral image frame (e.g., not the blend and foveated image frames), which can save area required for statistics collection, direct memory access (DMA), and the NOC module. For the systems and techniques, the addition of area for newly added logic and components to the ISP is negligible (e.g., less than 0.001 percent of the inline front end area of the ISP).

In one or more examples, the systems and techniques can provide the benefit of a reduction in DDR bandwidth. For example, for the systems and techniques, since statistics for only a peripheral image frame need to be written and read from the DDR, the overall DDR bandwidth is reduced as compared to writing and reading statistics for all three images frames (e.g., including the peripheral image frame, the blend image frame, and the foveated image frame). In cases where the peripheral image frame does not change much, but the foveated and blend image frames change, no statistics and LUT transactions for required from the DDR.

In some examples, the systems and techniques can provide the benefit of a reduction in the software (SW) workload. For the systems and techniques, since the software needs to read statistics for only a single context (e.g., a peripheral region) and determine configurations based on the statistics for only a single context (e.g., a peripheral region) instead of for three regions (e.g., including the peripheral region, the blend region, and the foveated region), the overall software workload is reduced.

In one or more examples, the systems and techniques can provide the benefit of providing a flexible solution. For example, the systems and techniques provide software configurable registers that can be used to determine which context image frame (e.g., the peripheral image frame) will be used for the next statistics collection and to determine the starting locations for the foveated and blend image frames to use to read the statistics (e.g., obtained from the peripheral image frame) from the LUT.

Additional aspects of the present disclosure are described in more detail below.

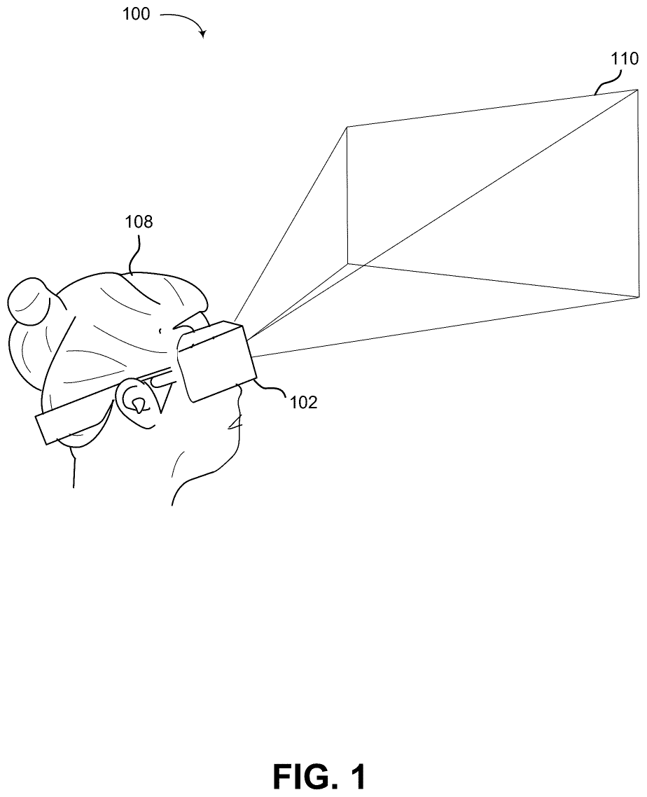

FIG. 1 is a diagram illustrating an example extended-reality (XR) system 100, according to aspects of the disclosure. As shown, XR system 100 includes an XR device 102. XR device 102 may implement, as examples, image-capture, object-detection, gaze-tracking, view-tracking, localization, computational and/or display aspects of extended reality, including virtual reality (VR), augmented reality (AR), and/or mixed reality (MR). For example, XR device 102 may include one or more scene-facing cameras that may capture images of a scene in which user 108 uses XR device 102. XR device 102 may detect objects in the scene based on the images of the scene. Further, XR device 102 may include one or more user-facing cameras that may capture images of eyes of user 108. XR device 102 may determine a gaze of user 108 based on the images of user 108. XR device 102 may determine an object of interest in the scene based on the gaze of user 108. XR device 102 may obtain and/or render information (e.g., text, images, and/or video based on the object of interest). XR device 102 may display the information to a user 108 (e.g., within a field of view 110 of user 108).

XR device 102 may display the information to be viewed by a user 108 in field of view 110 of user 108. For example, in a “see-through” configuration, XR device 102 may include a transparent surface (e.g., optical glass) such that information may be displayed on (e.g., by being projected onto) the transparent surface to overlay the information onto the scene as viewed through the transparent surface. In a “pass-through” configuration or a “video see-through” configuration, XR device 102 may include a scene-facing camera that may capture images of the scene of user 108. XR device 102 may display images or video of the scene, as captured by the scene-facing camera, and information overlaid on the images or video of the scene.

In various examples, XR device 102 may be, or may include, a head-mounted device (HMD), a virtual reality headset, and/or smart glasses. XR device 102 may include one or more cameras, including scene-facing cameras and/or user-facing cameras, a graphics processing unit (GPU), one or more sensors (e.g., such as one or more inertial measurement units (IMUs), image sensors, and/or microphones), and/or one or more output devices (e.g., such as speakers, display, and/or smart glass).

In some aspects, XR device 102 may be, or may include, two or more devices. For example, XR device 102 may include a display device and a processing device. The processing device may receive data from the display device, such as image data (e.g., from user-facing cameras and/or scene-facing cameras) and/or motion data (from an inertial measurement unit (IMU)). The processing device may process the data and/or other data. Further the processing unit may generate data to be displayed at the display device. The processing device and the display device may be communicatively connected, for example, wirelessly.

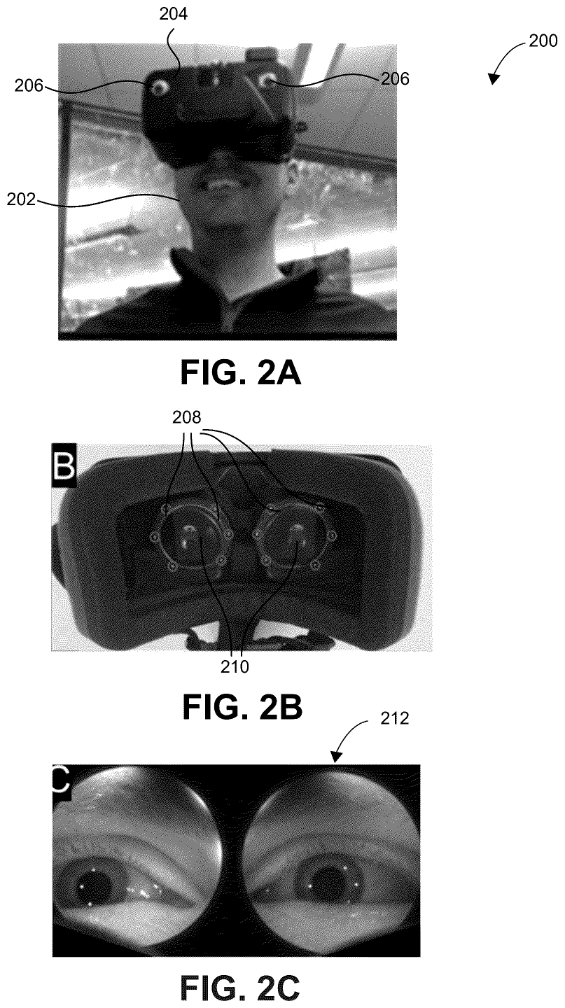

FIG. 2A is an illustration of a first view of a head-mounted device (HMD) 204, according to various aspects of the present disclosure. HMD 204 includes two scene-facing cameras 206. Scene-facing cameras 206 may capture images of a scene of a user 202 of HMD 204.

FIG. 2B is an illustration of a second view of HMD 204, according to various aspects of the present disclosure. FIG. 2B illustrates displays 210. Displays 210 may be configured to be positioned proximate to eyes of user 202 when user 202 wears HMD 204 on a head of user 202. FIG. 2B further illustrates user-facing cameras 208. User-facing cameras 208 may be configured to be positioned with a view of eyes of user 202 when 202 wears HMD 204.

FIG. 2C is an illustration of example images of eyes 212 of user 202, according to various aspects of the present disclosure. User-facing cameras 208 may capture images of eyes 212 of eyes of user 202 while user 202 is wearing HMD 204. HMD 204 may determine an orientation of eyes of user 202 based on images of eyes 212. Further, in some aspects, HMD 204 may determine a gaze of user 202 relative to displays 210 based on images of eyes 212. For example, HMD 204 may determine where, within displays 210, or within an image displayed by displays 210, user 202 is gazing. Additionally or alternatively, HMD 204 may determine a gaze of user 202 relative to a scene. For example, displays 210 may display images of a scene, for example, as captured by scene-facing camera 206. The images of the scene may be altered or augmented to provide an XR experience. HMD 204 may determine where in the scene user 202 is gazing based on images of eyes 212.

HMD 204 is illustrated in FIG. 2A and FIG. 2B as being configured to occlude an entirety of a field of view of user 202. Alternative HMDs may include one or more clear screens that may allow user 202 to view a scene of user 202 through the screens. Such alternative HMDs may include scene-facing cameras 206, user-facing cameras 208, and displays 210 (such displays 210 may be at least partially transparent). Such alternative HMDs may determine a gaze of user 202 relative to displays and/or relative to a scene of the user based on images captured by user-facing cameras 208.

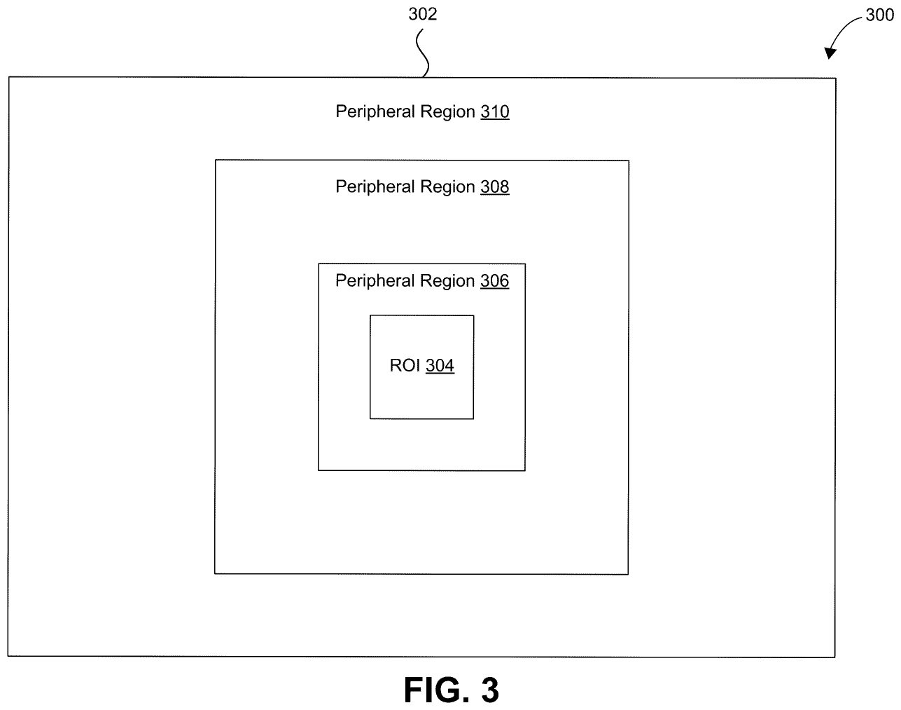

FIG. 3 is an illustration illustrating an example foveated image 300, according to various aspects of the present disclosure. Foveated image 300 has an image frame 302; further foveated image 300 includes an example region of interest (ROI) 304 and several example peripheral regions (e.g., a peripheral region 306, a peripheral region 308, and a peripheral region 310).

Image frame 302 may represent a full field of view of a camera. Image frame 302 may be based on an image sensor, for example, based on the size and shape of the image sensor and/or based on optical components (e.g., lenses) that focus light onto the image sensor.

ROI 304 may represent a region determined to be of interest. ROI 304 may be of any shape or size. In some aspects, a foveated image may include multiple ROIs. ROI 304 may have the highest resolution of foveated image 300.

The example foveated image 300 includes three tiered peripheral regions. For example, foveated image 300 includes a peripheral region 306 that may surround ROI 304. Peripheral region 306 may have a second-highest resolution of foveated image 300. Peripheral region 306 surrounds peripheral region 306 and may have a third-highest resolution of foveated image 300. Peripheral region 310 may be a remainder of foveated image 300 and may have the lowest resolution of foveated image 300.

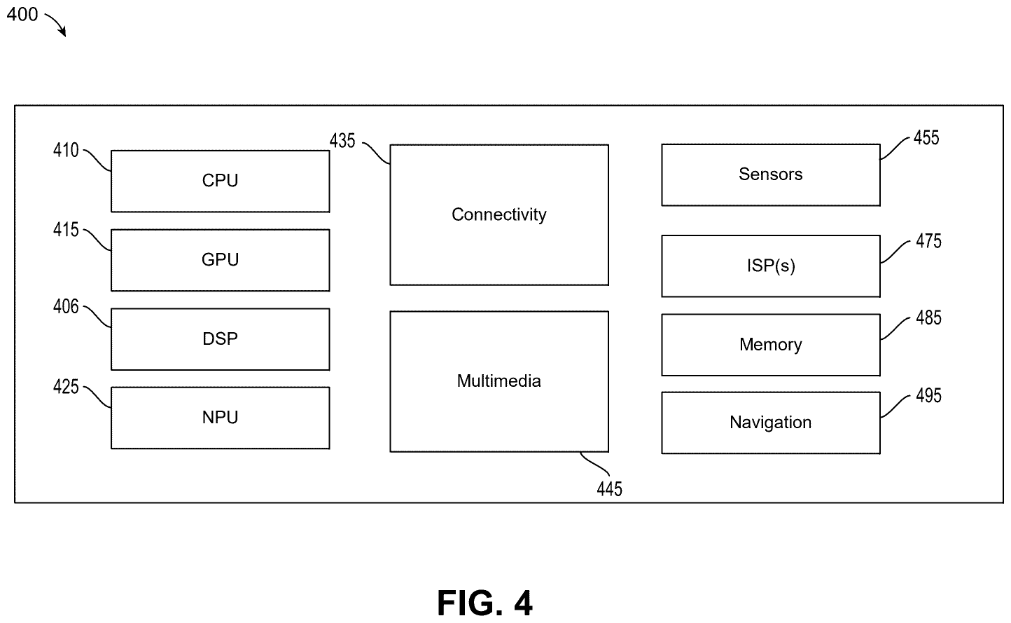

FIG. 4 illustrates an example implementation of a system-on-a-chip (SOC) 405, which may include a central processing unit (CPU) 410 or a multi-core CPU, configured to perform one or more of the functions described herein. In some cases, the SOC 405 may be based on an ARM instruction set. In some cases, CPU 410 may be similar to processor 464. Parameters or variables (e.g., neural signals and synaptic weights), system parameters associated with a computational device (e.g., neural network with weights), delays, frequency bin information, task information, among other information may be stored in a memory block associated with a neural processing unit (NPU) 425, in a memory block associated with a CPU 410, in a memory block associated with a graphics processing unit (GPU) 415, in a memory block associated with a digital signal processor (DSP) 406, in a memory block 485, and/or may be distributed across multiple blocks. Instructions executed at the CPU 410 may be loaded from a program memory associated with the CPU 410 or may be loaded from a memory block 485.

The SOC 405 may also include additional processing blocks tailored to specific functions, such as a GPU 415, a DSP 406, a connectivity block 435, which may include fifth generation (5G) connectivity, fourth generation long term evolution (4G LTE) connectivity, Wi-Fi connectivity, USB connectivity, Bluetooth connectivity, and the like, and a multimedia processor 445 that may, for example, detect and recognize gestures. In one implementation, the NPU is implemented in the CPU 410, DSP 406, and/or GPU 415. The SOC 405 may also include a sensor processor 455, image signal processors (ISPs) 475, and/or navigation module 495, which may include a global positioning system. In some cases, the navigation module 495 may be similar to navigation components 456 and sensor processor 455 may accept input from, for example, one or more sensors 458. In some cases, the connectivity block 435 may be similar to the radio module 472.

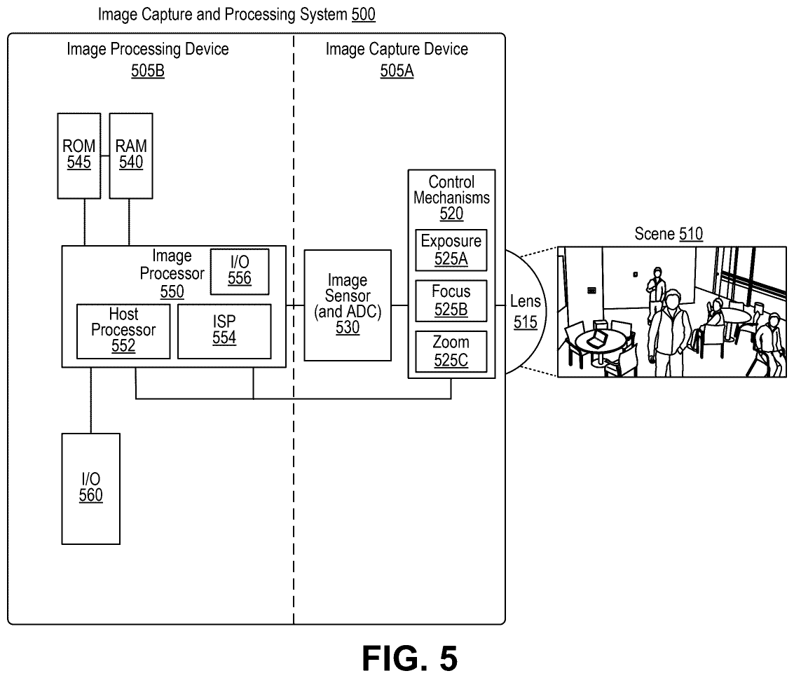

FIG. 5 is a block diagram illustrating an architecture of an image capture and processing system 500. The image capture and processing system 500 includes various components that are used to capture and process images of scenes (e.g., an image of a scene 510). The image capture and processing system 500 can capture standalone images (or photographs) and/or can capture videos that include multiple images (or video frames) in a particular sequence. A lens 515 of the system 500 faces a scene 510 and receives light from the scene 510. The lens 515 bends the light toward the image sensor 530. The light received by the lens 515 passes through an aperture controlled by one or more control mechanisms 520 and is received by an image sensor 530.

The one or more control mechanisms 520 may control exposure, focus, and/or zoom based on information from the image sensor 530 and/or based on information from the image processor 550. The one or more control mechanisms 520 may include multiple mechanisms and components; for instance, the control mechanisms 520 may include one or more exposure control mechanisms 525A, one or more focus control mechanisms 525B, and/or one or more zoom control mechanisms 525C. The one or more control mechanisms 520 may also include additional control mechanisms besides those that are illustrated, such as control mechanisms controlling analog gain, flash, HDR, depth of field, and/or other image capture properties.

The focus control mechanism 525B of the control mechanisms 520 can obtain a focus setting. In some examples, focus control mechanism 525B store the focus setting in a memory register. Based on the focus setting, the focus control mechanism 525B can adjust the position of the lens 515 relative to the position of the image sensor 530. For example, based on the focus setting, the focus control mechanism 525B can move the lens 515 closer to the image sensor 530 or farther from the image sensor 530 by actuating a motor or servo, thereby adjusting focus. In some cases, additional lenses may be included in the system 500, such as one or more microlenses over each photodiode of the image sensor 530, which each bend the light received from the lens 515 toward the corresponding photodiode before the light reaches the photodiode. The focus setting may be determined via contrast detection autofocus (CDAF), phase detection autofocus (PDAF), or some combination thereof. The focus setting may be determined using the control mechanism 520, the image sensor 530, and/or the image processor 550. The focus setting may be referred to as an image capture setting and/or an image processing setting.

The exposure control mechanism 525A of the control mechanisms 520 can obtain an exposure setting. In some cases, the exposure control mechanism 525A stores the exposure setting in a memory register. Based on this exposure setting, the exposure control mechanism 525A can control a size of the aperture (e.g., aperture size or f/stop), a duration of time for which the aperture is open (e.g., exposure time or shutter speed), a sensitivity of the image sensor 530 (e.g., ISO speed or film speed), analog gain applied by the image sensor 530, or any combination thereof. The exposure setting may be referred to as an image capture setting and/or an image processing setting.

The zoom control mechanism 525C of the control mechanisms 520 can obtain a zoom setting. In some examples, the zoom control mechanism 525C stores the zoom setting in a memory register. Based on the zoom setting, the zoom control mechanism 525C can control a focal length of an assembly of lens elements (lens assembly) that includes the lens 515 and one or more additional lenses. For example, the zoom control mechanism 525C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 515 in some cases) that receives the light from the scene 510 first, with the light then passing through an afocal zoom system between the focusing lens (e.g., lens 515) and the image sensor 530 before the light reaches the image sensor 530. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 525C moves one or more of the lenses in the afocal zoom system, such as the negative lens and one or both of the positive lenses.

The image sensor 530 includes one or more arrays of photodiodes or other photosensitive elements. Each photodiode measures an amount of light that eventually corresponds to a particular pixel in the image produced by the image sensor 530. In some cases, different photodiodes may be covered by different color filters, and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 530 may alternately or additionally include opaque and/or reflective masks that block light from reaching certain photodiodes, or portions of certain photodiodes, at certain times and/or from certain angles, which may be used for phase detection autofocus (PDAF). The image sensor 530 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 520 may be included instead or additionally in the image sensor 530. The image sensor 530 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 550 may include one or more processors, such as one or more image signal processors (ISPs) (including ISP 554), one or more host processors (including host processor 552), and/or one or more of any other type of processor 2010 discussed with respect to the computing system 2000. The host processor 552 can be a digital signal processor (DSP) and/or other type of processor. In some implementations, the image processor 550 is a single integrated circuit or chip (e.g., referred to as a system-on-chip or SoC) that includes the host processor 552 and the ISP 554. In some cases, the chip can also include one or more input/output ports (e.g., input/output (I/O) ports 556), central processing units (CPUs), graphics processing units (GPUs), broadband modems (e.g., 3G, 4G or LTE, 5G, etc.), memory, connectivity components (e.g., Bluetooth®, Global Positioning System (GPS), etc.), any combination thereof, and/or other components. The I/O ports 556 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 552 can communicate with the image sensor 530 using an I2C port, and the ISP 554 can communicate with the image sensor 530 using an MIPI port.

The image processor 550 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 550 may store image frames and/or processed images in random access memory (RAM) 540/2025, read-only memory (ROM) 545/2020, a cache 2012, a memory unit (e.g., system memory 2015), another storage device 2030, or some combination thereof.

Various input/output (I/O) devices 560 may be connected to the image processor 550. The I/O devices 560 can include a display screen, a keyboard, a keypad, a touchscreen, a trackpad, a touch-sensitive surface, a printer, any other output devices 2035, any other input devices 2045, or some combination thereof. In some cases, a caption may be input into the image processing device 505B through a physical keyboard or keypad of the I/O devices 560, or through a virtual keyboard or keypad of a touchscreen of the I/O devices 560. The I/O 560 may include one or more ports, jacks, or other connectors that enable a wired connection between the system 500 and one or more peripheral devices, over which the system 500 may receive data from the one or more peripheral device and/or transmit data to the one or more peripheral devices. The I/O 560 may include one or more wireless transceivers that enable a wireless connection between the system 500 and one or more peripheral devices, over which the system 500 may receive data from the one or more peripheral device and/or transmit data to the one or more peripheral devices. The peripheral devices may include any of the previously-discussed types of I/O devices 560 and may themselves be considered I/O devices 560 once they are coupled to the ports, jacks, wireless transceivers, or other wired and/or wireless connectors.

In some cases, the image capture and processing system 500 may be a single device. In some cases, the image capture and processing system 500 may be two or more separate devices, including an image capture device 505A (e.g., a camera) and an image processing device 505B (e.g., a computing device coupled to the camera). In some implementations, the image capture device 505A and the image processing device 505B may be coupled together, for example via one or more wires, cables, or other electrical connectors, and/or wirelessly via one or more wireless transceivers. In some implementations, the image capture device 505A and the image processing device 505B may be disconnected from one another.

As shown in FIG. 5, a vertical dashed line divides the image capture and processing system 500 of FIG. 5 into two portions that represent the image capture device 505A and the image processing device 505B, respectively. The image capture device 505A includes the lens 515, control mechanisms 520, and the image sensor 530. The image processing device 505B includes the image processor 550 (including the ISP 554 and the host processor 552), the RAM 540, the ROM 545, and the I/O 560. In some cases, certain components illustrated in the image capture device 505A, such as the ISP 554 and/or the host processor 552, may be included in the image capture device 505A.

The image capture and processing system 500 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 500 can include one or more wireless transceivers for wireless communications, such as cellular network communications, 802.11 wi-fi communications, wireless local area network (WLAN) communications, or some combination thereof. In some implementations, the image capture device 505A and the image processing device 505B can be different devices. For instance, the image capture device 505A can include a camera device and the image processing device 505B can include a computing device, such as a mobile handset, a desktop computer, or other computing device.

While the image capture and processing system 500 is shown to include certain components, one of ordinary skill will appreciate that the image capture and processing system 500 can include more components than those shown in FIG. 5. The components of the image capture and processing system 500 can include software, hardware, or one or more combinations of software and hardware. For example, in some implementations, the components of the image capture and processing system 500 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 500.

The host processor 552 can configure the image sensor 530 with new parameter settings (e.g., via an external control interface such as I2C, I3C, SPI, GPIO, and/or other interface). In one illustrative example, the host processor 552 can update exposure settings used by the image sensor 530 based on internal processing results of an exposure control algorithm from past image frames. The host processor 552 can also dynamically configure the parameter settings of the internal pipelines or modules of the ISP 554 to match the settings of one or more input image frames from the image sensor 530 so that the image data is correctly processed by the ISP 554. Processing (or pipeline) blocks or modules of the ISP 554 can include modules for lens (or sensor) noise correction, de-mosaicing, color conversion, correction or enhancement/suppression of image attributes, denoising filters, sharpening filters, among others. Each module of the ISP 554 may include a large number of tunable parameter settings. Additionally, modules may be co-dependent as different modules may affect similar aspects of an image. For example, denoising and texture correction or enhancement may both affect high frequency aspects of an image. As a result, a large number of parameters are used by an ISP to generate a final image from a captured raw image.

In some cases, the image sensor 530 can support dynamic switching between different operational modes that the image sensor 530 supports. Examples of the different operation modes include power off mode, software standby mode, stream on and off mode, among others. For instance, in stream operation mode, the image sensor is fully powered. With the stream operation on, the image sensor starts streaming image data (e.g., on the CSI-2 PHY layer port or interface). With the stream operation off, the image sensor stops streaming image data. In some cases, the host processor 552 can perform a dynamic parameter reconfiguration process that allows the image sensor 530 to support dynamic switching between the different operational modes without going through stream on and off and/or software standby procedures. Dynamic parameter reconfiguration refers to a process performed by the host processor 552 (e.g., an AP or other processor) to configure and update sensor internal register settings on-the-fly (e.g., as the operational modes change) without powering off the image sensor 530 and then powering on or putting the image sensor 530 into a software standby mode. Software standby mode refers to an operational mode of the image sensor 530 where the image sensor 530 is powered on and the camera control interface (CCI) communication is operational, but the image sensor 530 cannot capture and stream image data (e.g., on the CSI bus).

Such dynamic switching can reduce latency of mode switching processing and can improve user experience. Examples of the image sensor 530 dynamically switching between different operational modes include switching between turning high dynamic range (HDR) on and off, switching between a different number of exposures, switching between turning binning on and off (e.g., generating a 12 megapixel (MP) image using a 2×2 Quad Color Filter Array (QCFA) when binning is on and generating a 48 MP image by remosaicing the QCFA to a Bayer color filter array (CFA) when binning is off), among others.

Switching between operational modes (referred to as mode-switching scenarios) is different than changing image capture settings (referred to as non-mode-switching scenarios). For example, modifying image capture settings (e.g., exposure, focus, etc.) can result in a modification of how an image is captured and/or processed by the image sensor 530 and/or the ISP 554 (e.g., resulting in a brighter image, an image with a particular object in focus, etc.). However, if a setting of the image sensor 530 is incorrect or the image sensor 530 and/or ISP 554 are late in applying a setting in a non-mode-switching scenario, the result will be that a captured image is captured and/or processed with slight loss of quality in the processed image (e.g., without the intended settings, such as the image being slightly darker than intended, with an object slightly more out of focus than intended, etc.). However, when switching between operational modes in a mode-switching scenario (e.g., from HDR off to HDR on), applying the incorrect settings can result in a system failure, such as system hang or freeze, which can require a hardware reset of the ISP 554 and/or other components of the image capture and processing system 500. For instance, if the ISP 554 is unaware of the correct settings of an image frame produced by the image sensor 530 and mistakenly applies erroneous settings or parameters on that image frame for internal pipeline processing, the ISP 554 may freeze and require a hardware reset. As a result, instead of outputting an image frame with reduced quality, the image capture and processing system 500 may have to temporarily shut down and restart (e.g., the display screen may show a blank screen while the system 500 resets).

As previously mentioned, a foveated image sensor can capture three image frames (e.g., a peripheral image frame, a blend image frame, and a foveated image frame) with different resolutions in an interleaved manner. Each of the images frames captured can correspond to one of three regions, including a peripheral region, a blend region, and a foveated region (e.g., an ROI). In one or more examples, the foveated image frame has a higher resolution than the blend image frame, and the blend image frame has a higher resolution than the peripheral image frame.

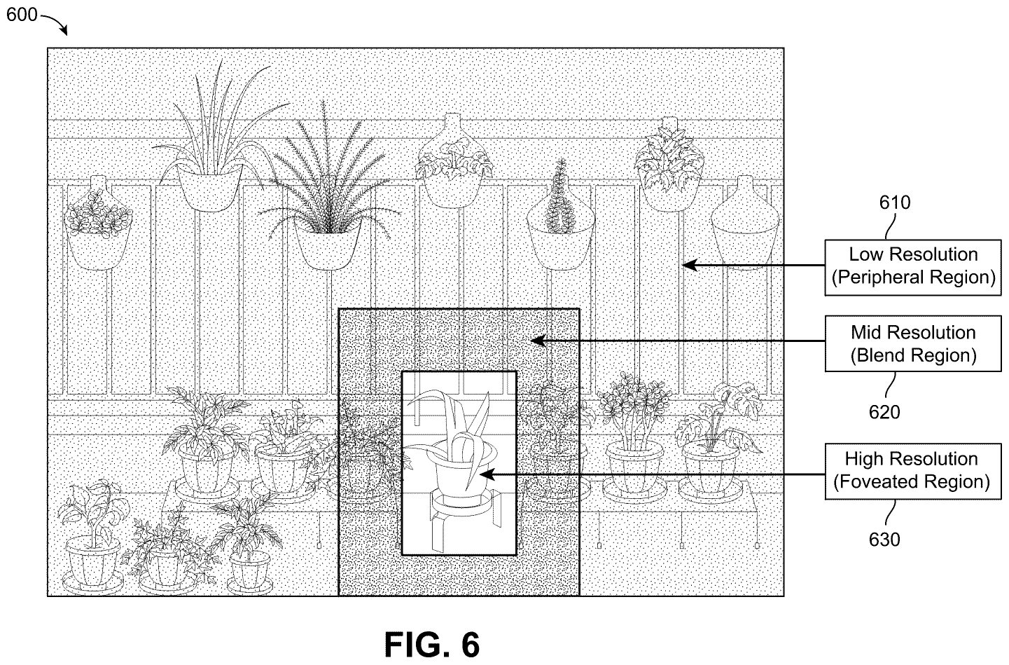

FIG. 6 shows an example of the three regions. In particular, FIG. 6 is a diagram illustrating an example of an image frame 600 (e.g., a peripheral image frame) including a peripheral region 610, a blend region 620, and a foveated region 630.

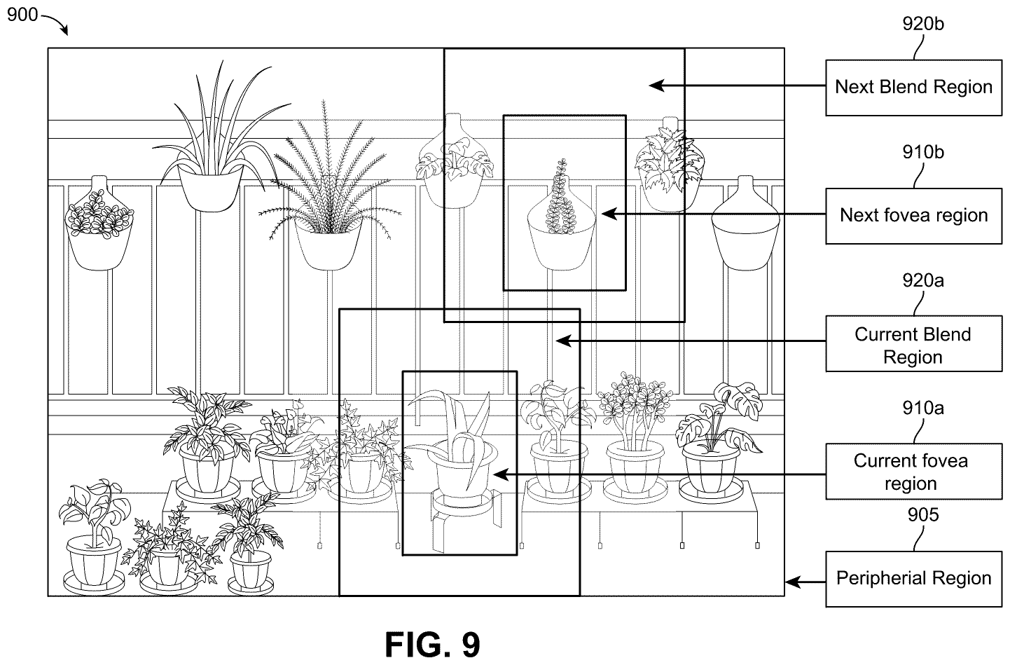

In one or more examples (e.g., some XR use case examples), a foveated region and a blend region can change per image frame, while a peripheral region may remain relatively stable (e.g., when an eye gaze changes, but there is minimal global motion). Current ISP architectures do not support a region (e.g., a foveated region) change per frame due to a statistics collection and computational delay (e.g., described in the descriptions of FIGS. 9, 10, and 11). An eye tracking prediction algorithm can predict the next foveated region and can inform the software such that ISP's registers can be programmed for the next region. However, for current ISP architectures, statistics-based configurations will be determined (e.g., computed) and applied after a minimum of a one frame delay (e.g., at least one subsequent frame needed to collect the statistics), which can result in IQ degradation.

Current ISP architectures employ a multi-context architecture, where an inline engine (e.g., an inline front end) receives three interleaved image frames (e.g., including a peripheral image frame including a peripheral region, a blend image frame including a blend region, and a foveated image frame including a foveated region) from an image sensor (e.g., a foveated image sensor). The inline engine employs three separate processing pipelines to process the three image frames. In this multi-context architecture, each image frame is treated as a separate context and is processed separately (e.g., using the three processing pipelines).

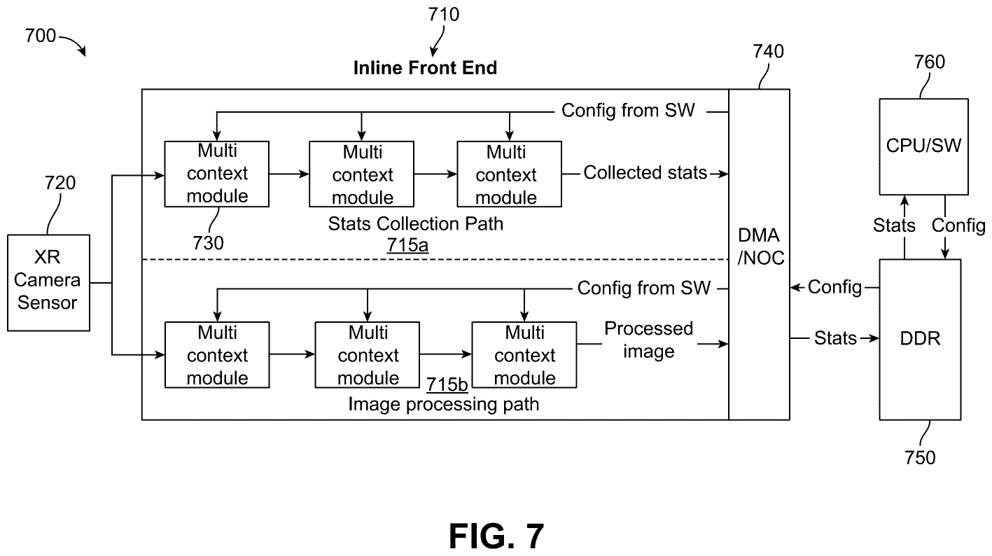

FIG. 7 shows an example of an inline engine (e.g., an inline front end) of the multi-context architecture of current ISP architectures. In particular, FIG. 7 is a diagram illustrating an example of a multi-context architecture 700 including an inline front end (IFE) 710 with multi-context modules 730 (referred to generally as modules). In FIG. 7, the IFE 710 is shown to include multiple multi-context modules 730 in both a statistics collection path 715a and an image processing path 715b. The modules 730 can perform statistics collection (e.g., from the image frames) and image processing tasks. The IFE 710 is also shown to include a DMA/NOC module 740. The multi-context architecture 700 is shown to also include an image sensor 720 (e.g., a foveated image sensor, which may be an XR camera sensor), DDR memory 750, and a CPU/SW module 760 (e.g., including a CPU running software).

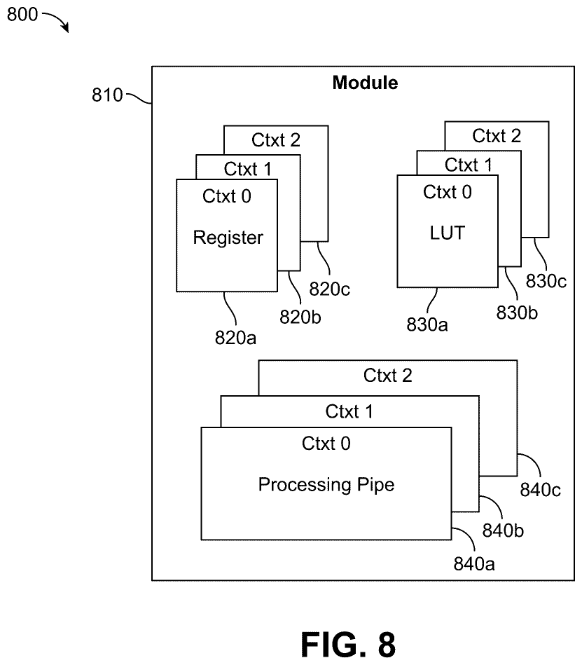

In one or more examples, the module 810 of FIG. 8 may be employed for each of the modules 730 of FIG. 7. FIG. 8 is a diagram illustrating an example 800 of a module 810, which may be employed for the IFE of FIG. 7. In FIG. 8, the module 810 includes separate registers 820a, 820b, 820c, lookup tables (LUTs) 830a, 830b, 830c, and processing pipelines 840a, 840b, 840c for each of the different contexts (e.g., context 0, context 1, context 2). In one or more examples, context 0 can be associated with the foveated region (associated with the foveated image frame), context 1 can be associated with the blend region (associated with the blend image frame), and context 2 can be associated with the peripheral region (associated with the peripheral image frame).

Referring back to FIG. 7, during operation of the multi-context architecture 700, the image sensor 720 can obtain (e.g., capture) a peripheral image frame of a peripheral region (e.g., peripheral region 610 of FIG. 6) of a scene, a blend image frame of a blend region (e.g., blend region 620 of FIG. 6) of the scene, and a foveated image frame of a foveated region (e.g., foveated region 630 of FIG. 6) of the scene. Within the statistics collection path 715a, the modules 730 can collect statistics from each of the three regions (e.g., each associated with one of the three image frames). In one or more examples, the statistics can include pixel values, luma values, and/or chroma values for the pixels within the peripheral image frame, the blend image frame, and the foveated image frame.

The modules 730 can send (e.g., transmit) the collected statistics to the DMA/NOC module 740, which can send (e.g., transmit) the statistics to the DDR memory 750 for storage. The CPU/SW module 760 can read the statistics from the DDR memory 750 and process the statistics independently for each context to produce a configuration (denoted as “config” in the figures) for each of the three regions (e.g., three image frames). In one or more examples, each of the configurations can include pixel values to be applied to one of the three image frames. The configurations are determined (e.g., computed), by the CPU/SW module 760, based on the statistics of the N^{th} image frame. The configurations will then be applied to the N+1^{th} image frame.

After the configurations are determined by the CPU/SW module 760, the configurations are sent (e.g., transmitted) to the modules 730 within the image processing path 715b, via the DDR memory 750 and the DMA/NOC module 740, for image processing. The modules 730 in the image processing path 715b can apply the configurations to the three image frames.

In one or more examples, in HDR use cases, image frames with different exposures will occur and need to be processed. Different exposures lead to different statistics and, hence, result in different configurations for each image frame. As such, the need for a dedicated set of registers and LUTs for each context (e.g., as shown in the module 810 of FIG. 8) can be justified.

However, the N^{th} image frame statistics-based configuration used for the N+1^{th} image frame can cause a degradation in IQ, as the foveated and blend regions can change per image frame (e.g., as described for FIGS. 9, 10, and 11). Foveated and blend image frames are treated (in the multi-context architecture) as a separate context and use dedicated LUT's, even though the foveated and blend image frames are a direct subset of the peripheral image frame.

As mentioned, for the multi-context architecture, statistics-based configurations for a current image frame (e.g., N+1^{th} frame) is based on statistics from a previous image frame (N^{th} frame). The foveated and blend regions can change per image frame, when the peripheral image frame is relatively stable (e.g., for an eye gaze changing with a minimal global motion). Using a configuration based on statistics from a previous image frame can result in IQ & VST degradation.

FIGS. 9, 10, and 11 show how using a configuration based on statistics from a previous image frame can result in degradation of image quality, and how using a configuration based on statistics from a current image frame can improve image quality. In particular, FIG. 9 is a diagram illustrating an example of an image frame 900 of a scene, where the image frame includes a peripheral region 905, a current foveated region 910a, a next foveated region 910b, a current blend region 920a, and a next blend region 920b.

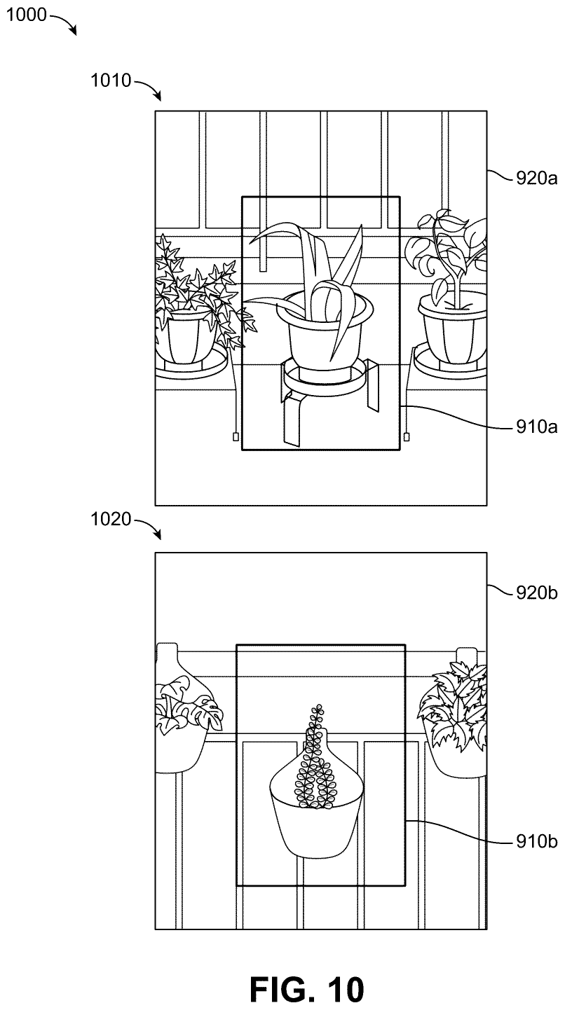

FIG. 10 is a diagram illustrating an example 1000 of an image frame 1010 including the current foveated region 910a of FIG. 9 and the current blend region 920a of FIG. 9, and an example of an image frame 1020 including the next foveated region 910b of FIG. 9 and the next blend region 920b of FIG. 9. In FIG. 10, the current foveated region 910a and the current blend region 920a are show to be darker (e.g., have darker pixels) as compared to the next foveated region 910b and the next blend region 920b.

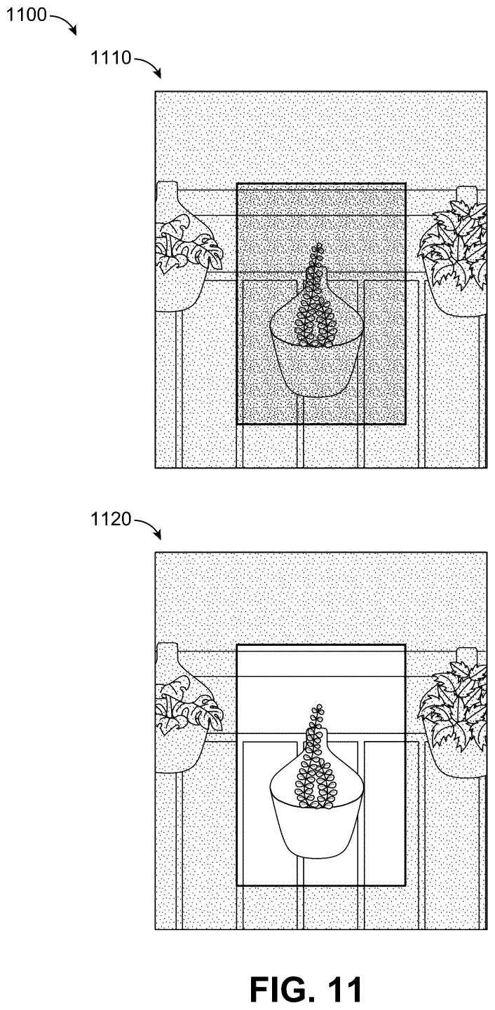

FIG. 11 is a diagram illustrating an example 1100 of an image frame 1110 resulting from a statistic-based configuration from the current foveated region 910a and the current blend region 910b being applied to the next foveated region 910b and next blend region 920b. The image frame 1110 shows that the pixels in the resultant image are saturated and, as such, there is a degradation in IQ.

The example 1100 of FIG. 11 also shows an image frame 1120 resulting from a statistic-based configuration from the next foveated region 910b and the next blend region 920b being applied to the next foveated region 910b and the next blend region 920b. The image frame 1120 does not exhibit saturation as does the image frame 1110 and, as such, the IQ of the image frame 1120 is improved as compared to the image frame 1110.

In the current ISP architectures (e.g., the multi-context architecture 700 of FIG. 7 including the modules 730 in the form of module 810 of FIG. 8), each context (e.g., associated with a specific region) has its own dedicated set of registers (e.g., registers 820a, 820b, 820c of FIG. 8), LUTs (e.g., LUTs 830a, 830b, 830c of FIG. 8), and processing pipelines (e.g., processing pipelines 840a, 840b, 840c of FIG. 8). The collection of the statistics (e.g., performed in the statistics collection path 715a of FIG. 7), the transfer of the collected statistics to the DDR memory (e.g., DDR memory 750 of FIG. 7), and the computation and configuration processing by the software running on the CPU (e.g., by the CPU/SW module 760 of FIG. 7) is performed per context (e.g., per region), which results in an increase the required area, DDR bandwidth, power, and software workload.

The foveated and the blend image frames are a subset of the peripheral image frame. For example, as shown in FIG. 6, the foveated image frame (e.g., associated with the foveated region) 630 and the blend image frame (e.g., associated with the blend region 620) are a subset of the peripheral image frame (e.g., associated with the peripheral region 610). As such, the statistics collected for the foveated and the blend image frames are also a subset of the statistics of the peripheral image frame. The current ISP architecture (e.g., the multi-context architecture 700 of FIG. 7 including the modules 730 in the form of module 810 of FIG. 8) does not support both a single context collection path and a multi-context image processing path.

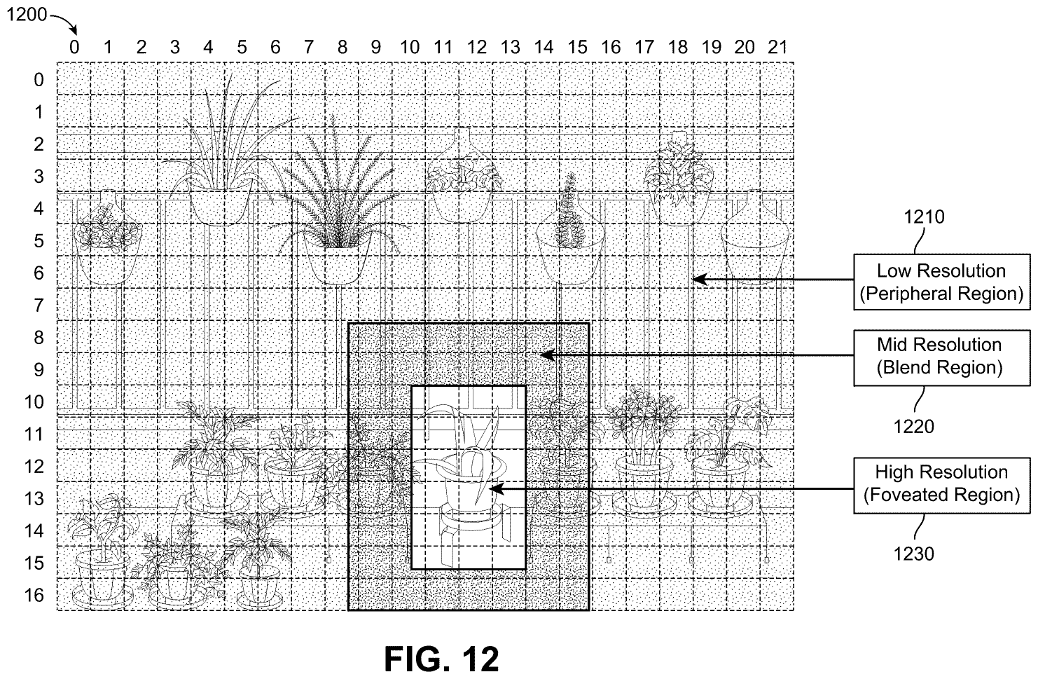

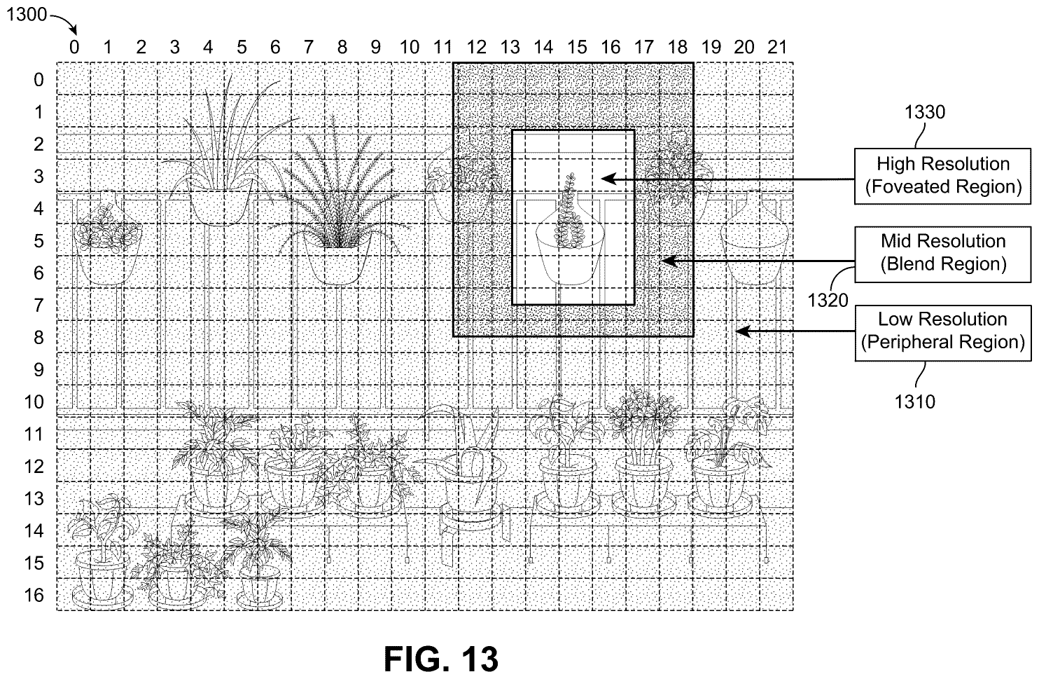

FIGS. 12 and 13 show examples of image frames where a foveated region and a blend region change locations per image frame, while a peripheral region remains relatively stable (e.g., when an eye gaze changes, but there is minimal global motion). In particular, FIG. 12 is a diagram illustrating an example of an image frame 1200 including a peripheral region 1210, a current blend region 1220, and a current foveated region 1230, where the image frame 1200 is shown to include a grid. In FIG. 12, the origin (0,0) of the grid is shown to be located at the upper left hand corner of the grid. A horizontal axis (x-axis) of the grid spans from zero to twenty-one, and a vertical axis (y-axis) of the grid spans from zero to sixteen.

FIG. 13 is a diagram illustrating an example of an image frame 1300 including a peripheral region 1310, a next blend region 1320, and a next foveated region 1330, where the image frame 1300 includes a grid. In FIG. 12, the origin (0,0) of the grid is shown to be located at the upper left hand corner of the grid. A horizontal axis (x-axis) of the grid spans from zero to twenty-one, and a vertical axis (y-axis) of the grid spans from zero to sixteen.

As shown in FIGS. 12 and 13, the blend region 1220, 1320 and the foveated region 1210, 1310 have changed locations per image frame (e.g., from image frame 1200 to image frame 1300), while the peripheral region 1230, 1330 has remained the same (e.g., remained stable) in both of the image frames 1200, 1300.

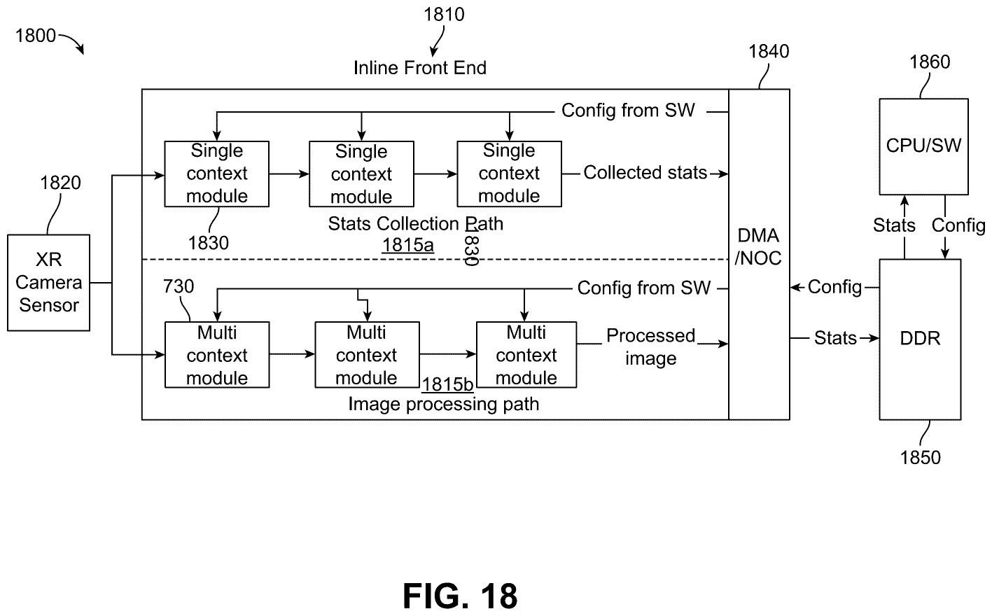

In one or more aspects, the systems and techniques provide solutions for an image signal processor to improve IQ as well as to reduce area, power, and DDR bandwidth. In one or more examples, the systems and techniques provide an architecture (e.g., architecture 1800 of FIG. 18) for an ISP that solves the IQ degradation issue (e.g., as shown in FIGS. 9, 10, and 11) by removing the delay (e.g., frame delay) associated with the statistics collection, while also allowing for a reduction in area, power, DDR bandwidth, and the software workload. Since the foveated image frame and the blend image frame are subsets of the peripheral image frame, the statistics for the foveated image frame and the statistics for the blend image frame are also subsets of peripheral image frame. As such, the systems and techniques use select parts of the statistics of the peripheral image frame for the processing of the foveated image frame and the blend image frame.

In some aspects, the systems and techniques employ a shared LUT. The LUT associated with the peripheral image frame has a configuration for entire image. Since the foveated and blend image frames are inherently part of the peripheral image frame (e.g., as shown in FIG. 6), configurations for the foveated image frame and the blend image frame are also present within the LUT associated with the peripheral image frame. As such, the LUT associated with the peripheral image frame may operate as a shared LUT that is associated with the peripheral image frame, the blend image frame, and the foveated image frame.

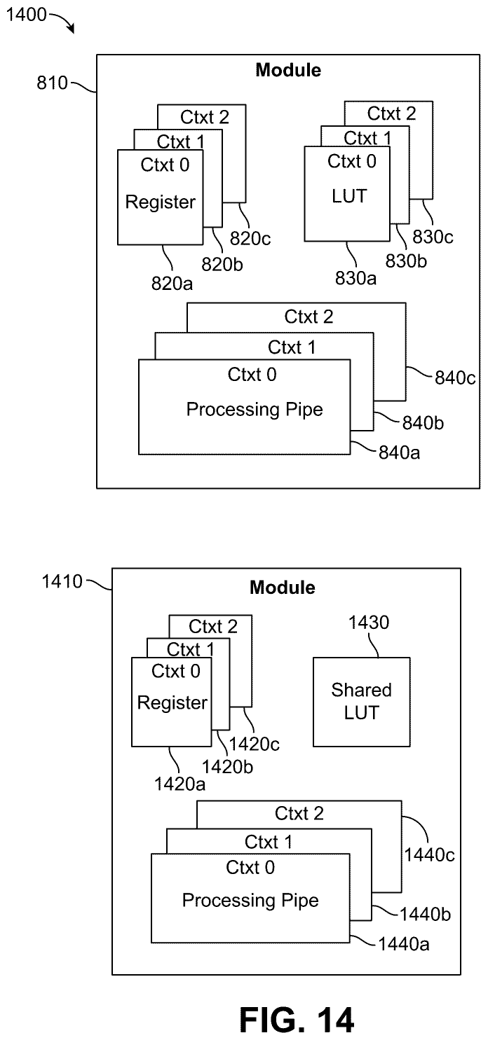

FIG. 14 shows an example of a module with a shared LUT. In particular, FIG. 14 is a diagram illustrating an example 1400 of the module 810 of FIG. 8, which may be employed for the IFE 710 of FIG. 7, and an example of a module 1410, which may be employed for the IFE 1810 of FIG. 18, including a shared LUT 1430 and separate registers 1420a, 1420b, 1420c and processing pipelines 1440a, 1440b, 1440c for three different contexts (e.g., associated with a peripheral image frame, a blend image frame, and a foveated image frame). The shared LUT 1430 is associated with the peripheral image frame, the blend image frame, and the foveated image frame.

In one or more examples, the systems and techniques allow for real time access (e.g., with no delay due to statistics collection and computation) to configurations for the foveated and blend image frames based on respective starting locations (e.g., within the statistics in the shared LUT) for the statistics associated with the foveated image frame and the statistics associated with the blend image frame. The systems and techniques apply a current image frame's configuration, instead of a previous image frame's configuration, to improve IQ and to ensure tone consistency (e.g., within the foveated image frame and the blend image frame).

In one or more aspects, the systems and techniques employ registers for each context that will point to respective starting locations (e.g., X, Y) within the statistics associated with the peripheral image frame for the foveated image frame and the blend image frame. In one or more examples, the systems and techniques also employ additional LUT address generation logic for updating the shared LUT to start addressing from a location in the statistics (e.g., within the shared LUT) pointed to by these registers the foveated image frame, the blend image frame, and the peripheral image frame.

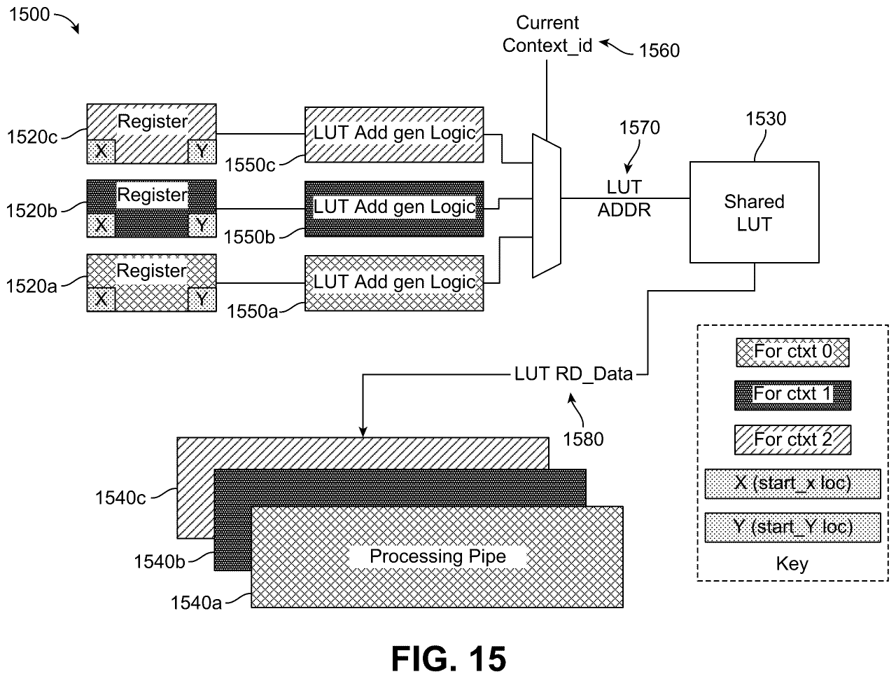

FIG. 15 shows an example of these registers (e.g., which point to starting locations within the statistics) and additional LUT address generation logic. In particular, FIG. 15 is a diagram illustrating an example of a module 1500, which may be employed for the IFE 1810 of FIG. 18, including shared LUT addressing logic. In FIG. 15, the module 1500 is shown to include registers 1520a, 1520b, 1520c, a shared LUT 1530, processing pipelines 1540a 1540b, 1540c, LUT address generation logic 1550a, 1550b, 1550c. During operation of the module 1550, the registers 1520a, 1520b, 1520c (e.g., which are each associated with a respective context) include respective starting locations (X, Y) within the statistics (e.g., stored within the shared LUT 1530) associated with the peripheral image frame for determining respective configurations for the peripheral image frame, the blend image frame, and the foveated image frame. The starting locations each indicate a respective pixel within the peripheral image frame for the shared LUT 1530 to point to for addressing (e.g., to start reading) the statistics.

For example, register 1520a includes a starting location (X₀, Y₀, such as 0,0) within the statistics (e.g., stored within the shared LUT 1530) associated with the peripheral image frame for using to determine a configuration for the peripheral image frame. Register 1520b includes a starting location (X₁, Y₁) within the statistics (e.g., stored within the shared LUT 1530) associated with the peripheral image frame for using to determine a configuration for the blend image frame. Register 1520c includes a starting location (X₂, Y₂) within the statistics (e.g., stored within the shared LUT 1530) associated with the peripheral image frame for using to determine a configuration for the foveated image frame.

Each of the registers 1520a, 1520b, 1520c can send their respective starting locations to respective LUT address generation logic 1550a, 1550b, 1550c. The LUT address generation logic 1550a, 1550b, 1550c can update, based on the starting locations, the shared LUT 1530 to point to (e.g., start addressing from) the locations in the statistics. In one or more examples, the LUT address generation logic 1550a, 1550b, 1550c can convert, based on a current context identification (ID) 1560, each of the starting locations (X, Y) to a LUT address 1570, which can be used by the shared LUT 1530 to start addressing within the statistics. For example, the LUT address generation logic 1550a can convert, based on a current context ID 1560, the starting location (X₀, Y₀, such as 0,0) to a LUT address 1570. The shared LUT 1530 can then start addressing in (e.g., reading) the statistics (e.g., stored within the shared LUT 1530), according to (e.g., based on) the LUT address 1570.

After the statistics are read by the shared LUT 1530, the shared LUT 1530 can send (e.g., transmit) the read statistics (e.g., LUT read data 1580) to the processing pipelines 1540a 1540b, 1540c for processing. For example, the statistics read by the shared LUT 1530 (e.g., based on the LUT address for the peripheral image frame) can then be sent (e.g., transmitted) to the processing pipeline 1540a for processing.

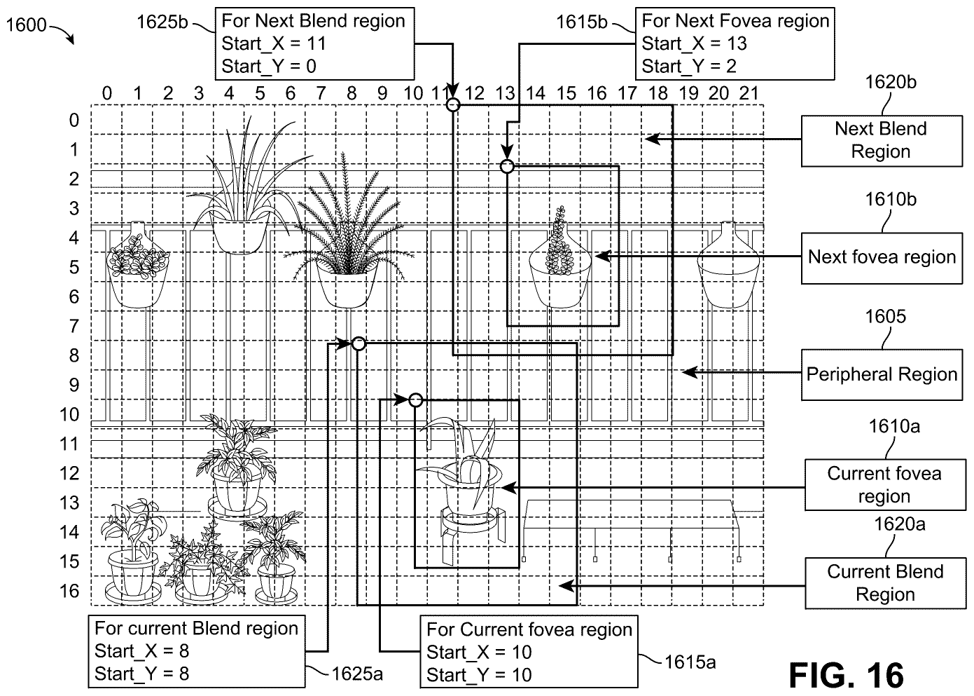

FIG. 16 shows examples of starting locations for current and next foveated and blend image frames. In particular, FIG. 16 is a diagram illustrating an example of an image frame 1600 including example starting locations 1625a, 1625b, 1615a, 1615b for a current blend region 1620a, a next blend region 1620b, a current foveated region 1610a, and a next foveated region 1610b. The image frame 1600 includes a peripheral region 1605 with a plurality of pixels, where each pixel has corresponding statistics (e.g., including a pixel value, a luma value, and/or a chroma value).

FIG. 16 is shown to include a grid. In FIG. 16, the origin (0,0) of the grid is shown to be located at the upper left hand corner of the grid. A horizontal axis (x-axis) of the grid spans from zero to twenty-one, and a vertical axis (y-axis) of the grid spans from zero to sixteen. Each of the starting locations 1625a, 1625b, 1615a, 1615b is denoted by a black dot (e.g., located on the grid) within the image frame 1600. Each of the starting locations (e.g., black dots) is shown to be located on a upper left hand corner of its respective region. In FIG. 16, the starting location 1625a of (8,8) is shown for the current blend region 1620a, the starting location 1625b of (11,0) is shown for the next blend region 1620b, the starting location 1615a of (10,10) is shown for the current foveated region 1610a, and the starting location 1615b of (13,2) is shown for the next foveated region 1610b.

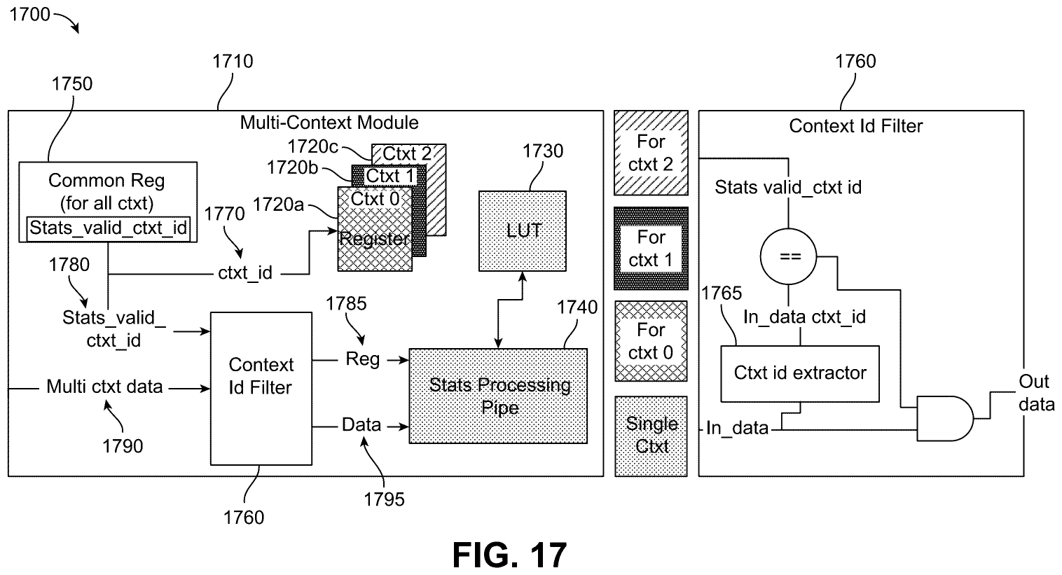

In one or more aspects, the systems and techniques provide an ISP architecture (e.g., architecture 1800) that supports both single context statistics collection and multi-context image processing pipeline. FIG. 17 shows an example of a single context statistics collection module that may be employed by the ISP architecture. In particular, FIG. 17 is a diagram illustrating an example 1700 of a module 1710, which may be employed for the IFE 1810 of FIG. 18, including shared LUT addressing logic. In FIG. 17, the module 1710 is shown to include a shared LUT 1730 and registers 1720a, 1720b, 1720c for the different contexts.

The module 1710 is also shown to include a context ID filter 1760 to select peripheral image frames and to filter out foveated and blend image frames. The context ID filter 1760 can be located prior to a shared statistics processing pipeline 1740 (e.g., associated with the peripheral image frame; and associated with the blend image frame and the foveated image frame since the peripheral image frame includes the blend and foveated image frames).

The module 1710 can also include a common register 1750 that can indicate (e.g., by outputting stats_valid_ctxt_id 1780) that a context ID 1770 for a peripheral frame is present. The stats_valid_ctxt_id 1780 and multi-context data 1790 can be input into the context ID filter 1760. The context ID filter 1760, based on the stats_valid_ctxt_id 1780 and multi-context data 1790, can filter out register information 1785 and data 1795. In particular, a context ID extractor 1765 of the context ID filter 1760 can extract, based on the stats_valid_ctxt_id 1780, the data 1795 (e.g., associated with a peripheral frame) from the multi-context data 1790 (e.g., associated with a peripheral image frame, a blend image frame, and a foveated image frame). The register information 1785 and data 1795 are shown to be inputted into the shared statistics processing pipeline 1740 for processing. As such, the module 1710 can operate as a single context statistics collection pipeline (e.g., for processing peripheral image frame statistics), which can result in a reduction in area and power.

FIG. 18 shows an example of an ISP architecture that supports both single context statistics collection and multi-context image processing pipeline. In particular, FIG. 18 is a diagram illustrating an example of an architecture 1800 including an IFE 1810 with both single-context modules 1830 and multi-context modules 730. In one or more examples, the architecture 1800 may be within a device, such as an XR device. In FIG. 18, the IFE 1810 is shown to include multiple single context modules 1830 in a statistics collection path 1815a and multiple multi-context modules 730 in an image processing path 1815b. The modules 1830 can perform statistics collection (e.g., from the image frames), and the modules 730 can perform image processing tasks. The IFE 1810 is also shown to include a DMA/NOC module 1840. The multi-context architecture 1800 is shown to include an image sensor 1820 (e.g., a foveated image sensor, which may be an XR camera sensor), DDR memory 1850, and a CPU/SW module 1860 (e.g., including a CPU running software). In one or more examples, the module 1410 of FIG. 14, the module 1500 of FIG. 15, the module 1710 of FIG. 17, or a combination thereof may be employed for each of the modules 1830 of FIG. 18.

During operation of the architecture 1800, the image sensor 1820 (e.g., a foveated image sensor) can obtain (e.g., capture) a peripheral image frame of a peripheral region (e.g., peripheral region 610 of FIG. 6) of a scene, a blend image frame of a blend region (e.g., blend region 620 of FIG. 6) of the scene, and a foveated image frame of a foveated region (e.g., foveated region 630 of FIG. 6) of the scene. In one or more examples, the foveated image frame can have a higher resolution than the blend image frame, and the blend image frame can have a higher resolution of the peripheral image frame.

Within the statistics collection path 1815a, the modules 1830 can collect statistics from the peripheral region (e.g., each associated with the peripheral image frame). In one or more examples, the statistics can include a respective pixel value, a respective luma value, and/or a respective chroma value associated with each pixel of a plurality of pixels of the peripheral image frame. In some examples, one or more processors (e.g., within a shared processing pipeline, such as shared processing pipeline 1740 of FIG. 17) of the module 1830 can determine, based on the peripheral image frame, statistics for the peripheral image frame. In one or more examples, the shared processing pipeline can be associated with the peripheral image frame, the blend image frame, and the foveated image frame. In one or more examples, the statistics can be stored within a shared LUT (e.g., shared LUT 1430 of FIG. 14, shared LUT 1530 of FIG. 15, or shared LUT 1730 of FIG. 17) associated with the peripheral image frame, the blend image frame, and the foveated image frame. The statistics stored within the shared LUT can be associated with the peripheral image frame, the blend image frame, and the foveated image frame.

In one or more examples, a first register (e.g., register 1420b of FIG. 14, register 1520b of FIG. 15, or register 1720b of FIG. 17) associated with the blend image frame, can determine the first starting location within the statistics. In one or more examples, a second register (e.g., register 1420c of FIG. 14, register 1520c of FIG. 15, or register 1720c of FIG. 17) associated with the foveated image frame, can determine the second starting location within the statistics. In one or more examples, a first LUT address generation logic (e.g., LUT address generation logic 1550b) associated with the blend image frame can update the shared LUT to point to the first starting location within the statistics. In some examples, a second LUT address generation logic (e.g., LUT address generation logic 1550c) associated with the foveated image frame can update the shared LUT to point to the second starting location within the statistics. In one or more examples, the first starting location and the second starting location within the statistics can each indicate a respective pixel of the plurality of pixels of the peripheral image frame to start reading the statistics.

The modules 1830 can send (e.g., transmit) the statistics to the DMA/NOC module 1840, which can send (e.g., transmit) the statistics to the DDR memory 1850 for storage. The CPU/SW module 1860 can read the statistics from the DDR memory 1850 and process the statistics to produce a configuration for each of the three regions (e.g., associated with the three image frames). In one or more examples, one or more processors (e.g., of the CPU/SW module) can determine (e.g., based on a first starting location within the statistics) a first configuration for the blend image frame. The one or more processors (e.g., of the CPU/SW module) can determine (e.g., based on a second starting location within the statistics) a second configuration for the foveated image frame. In one or more examples, the first configuration can include a respective blend pixel value, a respective blend luma value, or a respective blend chroma value associated with each pixel of a plurality of pixels of the blend image frame. In some examples, the second configuration can include a respective foveated pixel value, a respective foveated luma value, or a respective foveated chroma value associated with each pixel of a plurality of pixels of the foveated image frame.

In one or more examples, each of the configurations can include pixel values to be applied to one of the three image frames. The configurations are determined (e.g., computed), by the CPU/SW module 1860, based on the statistics of the N^{th} peripheral image frame. The configurations will then be applied to the N^{th} peripheral image frame, the N^{th} blend image frame, and the N^{th} foveated image frame.

After the configurations are determined by the CPU/SW module 1860, the configurations can be sent (e.g., transmitted) to the modules 730 within the image processing path 1815b, via the DDR memory 1850 and the DMA/NOC module 1840, for image processing. The modules 730 in the image processing path 1815b can apply the configurations to the three image frames. In some examples, one or more processors (e.g., of a shared processing pipeline, such as shared processing pipeline 1740 of FIG. 17) can apply the first configuration to the blend image frame. The one or more processors (e.g., of a shared processing pipeline, such as shared processing pipeline 1740 of FIG. 17) can apply the second configuration to the foveated image frame.

As such, for the architecture 1800, statistics from only one image frame (e.g., the peripheral image frame) are collected and inputted into the DDR memory 1850, which will lead to a reduction in DDR bandwidth and power. Also for the architecture 1800, statistics from only one image frame are utilized for configuration computations, which reduces the software (e.g., within the CPU/SW modules 1860) workload.

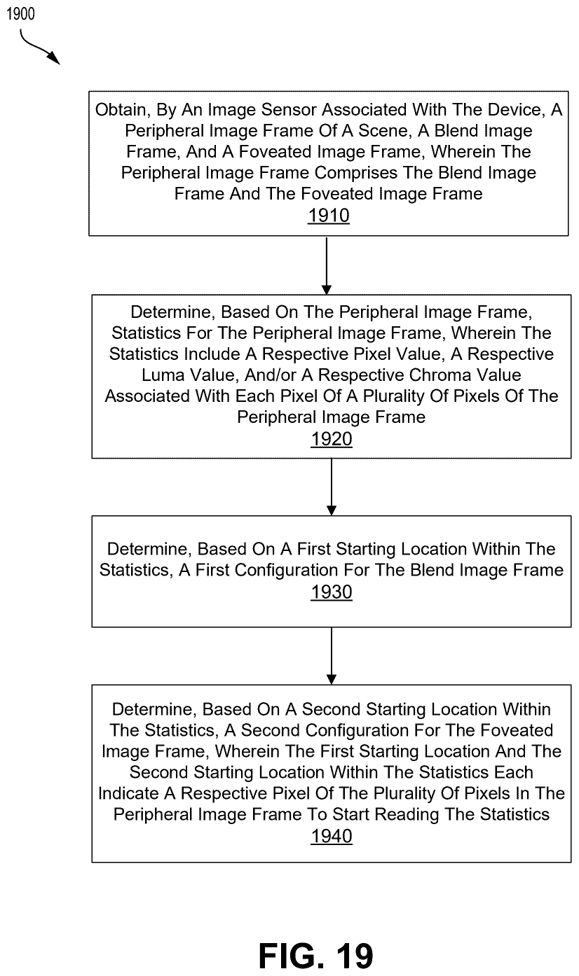

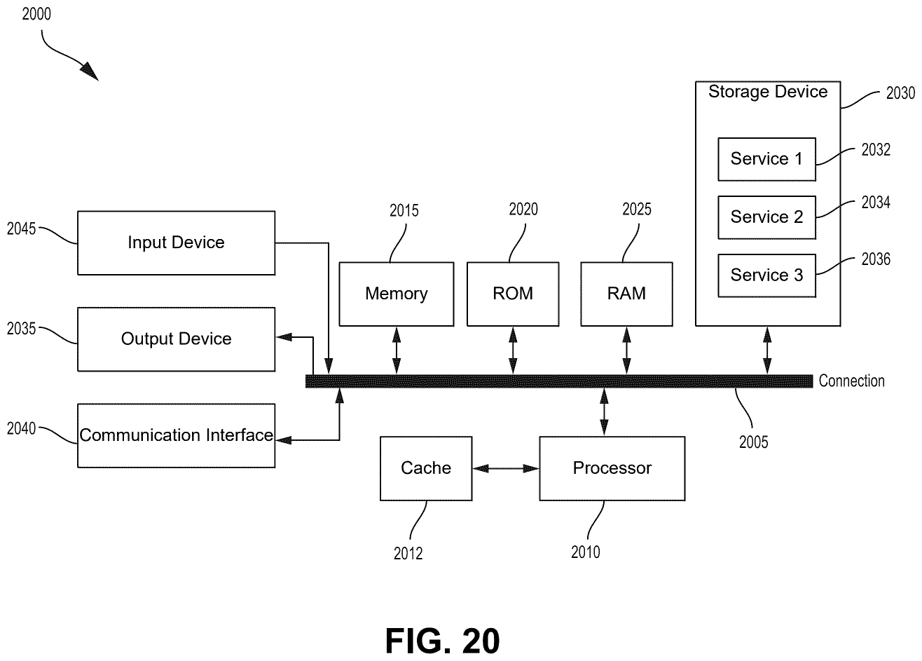

FIG. 19 is a flow chart illustrating an example of a process 1900 for image processing. The process 1900 can be performed by a computing device or by a component or system (e.g., the system 400 of FIG. 4, the image capture and processing system 500 of FIG. 5, the computing system 2000 of FIG. 20, a chipset, one or more processors central processing units (CPUs), digital signal processors (DSPs), graphics processing units (GPUs), any combination thereof, and/or other type of processor(s), any combination thereof, and/or other component or system) of the computing device. In some cases, the computing device is an extended reality (XR) device, a vehicle (or component or system of the vehicle), or other device. The operations of the process 1900 may be implemented as software components that are executed and run on one or more processors (e.g., processor 2010 of FIG. 20, or other processor(s)). Further, the transmission and reception of signals by the computing device in the process 1900 may be enabled, for example, by one or more antennas and/or one or more transceivers (e.g., wireless transceiver(s)).

At block 1910, the computing device (or component thereof) can obtain, from an image sensor, a peripheral image frame (e.g., including the peripheral region 1310 of FIG. 13) of a scene, a blend image frame (e.g., including the blend region 1320 of FIG. 13), and a foveated image frame (e.g., including the foveated region 1330 of FIG. 13). The peripheral image frame includes the blend image frame and the foveated image frame. The foveated image frame has a higher resolution than the blend image frame and the blend image frame has a higher resolution than the peripheral image frame. In some aspects, the image sensor is a foveated image sensor. In some cases, the computing device includes the image sensor (and possibly other image sensors).

At block 1920, the computing device (or component thereof) can determine, based on the peripheral image frame, statistics for the peripheral image frame. For instance, the statistics can include a respective pixel value, a respective luma value, and/or a respective chroma value associated with each pixel of a plurality of pixels of the peripheral image frame.

At block 1930, the computing device (or component thereof) can determine, based on a first starting location within the statistics, a first configuration for the blend image frame. In some aspects, the first configuration includes a respective blend pixel value, a respective blend luma value, and/or a respective blend chroma value associated with each pixel of a plurality of pixels of the blend image frame.

At block 1940, the computing device (or component thereof) can determine, based on a second starting location within the statistics, a second configuration for the foveated image frame. The first starting location and the second starting location within the statistics each indicate a respective pixel of the plurality of pixels of the peripheral image frame to start reading the statistics (e.g., as described with respect to 15). In some aspects, the second configuration includes a respective foveated pixel value, a respective foveated luma value, and/or a respective foveated chroma value associated with each pixel of a plurality of pixels of the foveated image frame.

In some cases, the computing device (or component thereof) can apply the first configuration to the blend image frame and can apply the second configuration to the foveated image frame. In some cases, the computing device (or component thereof) can apply the first configuration to the blend image frame and the second configuration to the foveated image frame using a shared processing pipeline (e.g., the shared processing pipeline 1740 of FIG. 17) associated with the peripheral image frame, the blend image frame, and the foveated image frame. In some aspects, the computing device (or component thereof) can determine the statistics for the peripheral image frame using the shared processing pipeline associated with the peripheral image frame, the blend image frame, and the foveated image frame. In some aspects, the statistics are stored within a shared lookup table (LUT) (e.g., the shared LUT 1530 of FIG. 15, the LUT 1730 of FIG. 17, or other shared LUT) associated with the peripheral image frame, the blend image frame, and the foveated image frame. For instance, the shared processing pipeline can output the statistics to the shared LUT and/or can obtain (e.g., access, retrieve, receive, etc.) the statistics from the shared LUT (e.g., as shown in FIG. 17). The statistics stored within the shared LUT are associated with the peripheral image frame, the blend image frame, and the foveated image frame.

In some aspects, the computing device (or component thereof) can determine, by a first register (e.g., register 1420b of FIG. 14, register 1520b of FIG. 15, or register 1720b of FIG. 17) associated with the blend image frame, the first starting location within the statistics. The computing device (or component thereof) can determine, by a second register (e.g., register 1420c of FIG. 14, register 1520c of FIG. 15, or register 1720c of FIG. 17) associated with the foveated image frame, the second starting location within the statistics.

In some cases, the computing device (or component thereof) can update the shared LUT to point to the first starting location within the statistics and can update the shared LUT to point to the second starting location within the statistics. For instance, as previously described, a first LUT address generation logic (e.g., LUT address generation logic 1550b of FIG. 15) associated with the blend image frame can update the shared LUT to point to the first starting location within the statistics. In another example, a second LUT address generation logic (e.g., LUT address generation logic 1550c) associated with the foveated image frame can update the shared LUT to point to the second starting location within the statistics.

In some cases, the computing device of process 1900 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth® standard, data according to the Internet Protocol (IP) standard, and/or other types of data.

The components of the computing device of process 1900 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1900 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1900 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 20 is a block diagram illustrating an example of a computing system 2000, which may be employed to improve IQ and reduce area, power, and DDR bandwidth. In particular, FIG. 20 illustrates an example of computing system 2000, which can be for example any computing device making up internal computing system, a remote computing system, a camera, or any component thereof in which the components of the system are in communication with each other using connection 2005. Connection 2005 can be a physical connection using a bus, or a direct connection into processor 2010, such as in a chipset architecture. Connection 2005 can also be a virtual connection, networked connection, or logical connection.

In some aspects, computing system 2000 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 2000 includes at least one processing unit (CPU or processor) 2010 and connection 2005 that communicatively couples various system components including system memory 2015, such as read-only memory (ROM) 2020 and random access memory (RAM) 2025 to processor 2010. Computing system 2000 can include a cache 2012 of high-speed memory connected directly with, in close proximity to, or integrated as part of processor 2010.

Processor 2010 can include any general purpose processor and a hardware service or software service, such as services 2032, 2034, and 2036 stored in storage device 2030, configured to control processor 2010 as well as a special-purpose processor where software instructions are incorporated into the actual processor design. Processor 2010 may essentially be a completely self-contained computing system, containing multiple cores or processors, a bus, memory controller, cache, etc. A multi-core processor may be symmetric or asymmetric.

To enable user interaction, computing system 2000 includes an input device 2045, which can represent any number of input mechanisms, such as a microphone for speech, a touch-sensitive screen for gesture or graphical input, keyboard, mouse, motion input, speech, etc. Computing system 2000 can also include output device 2035, which can be one or more of a number of output mechanisms. In some instances, multimodal systems can enable a user to provide multiple types of input/output to communicate with computing system 2000.

Computing system 2000 can include communications interface 2040, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 2040 may also include one or more range sensors (e.g., LiDAR sensors, laser range finders, RF radars, ultrasonic sensors, and infrared (IR) sensors) configured to collect data and provide measurements to processor 2010, whereby processor 2010 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 2040 may also include one or more Global Navigation Satellite System (GNSS) receivers or transceivers that are used to determine a location of the computing system 2000 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 2030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 2030 can include software services, servers, services, etc., that when the code that defines such software is executed by the processor 2010, it causes the system to perform a function. In some aspects, a hardware service that performs a particular function can include the software component stored in a computer-readable medium in connection with the necessary hardware components, such as processor 2010, connection 2005, output device 2035, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus for image processing, the apparatus comprising: at least one memory; and at least one processor coupled to the at least one memory and configured to: obtain, from an image sensor, a peripheral image frame of a scene, a blend image frame, and a foveated image frame, wherein the peripheral image frame comprises the blend image frame and the foveated image frame; determine, based on the peripheral image frame, statistics for the peripheral image frame, wherein the statistics comprise at least one of a respective pixel value, a respective luma value, or a respective chroma value associated with each pixel of a plurality of pixels of the peripheral image frame; determine, based on a first starting location within the statistics, a first configuration for the blend image frame; and determine, based on a second starting location within the statistics, a second configuration for the foveated image frame, wherein the first starting location and the second starting location within the statistics each indicate a respective pixel of the plurality of pixels of the peripheral image frame to start reading the statistics.

Aspect 2. The apparatus of Aspect 1, wherein the first configuration comprises a respective blend pixel value, a respective blend luma value, or a respective blend chroma value associated with each pixel of a plurality of pixels of the blend image frame, and wherein the second configuration comprises a respective foveated pixel value, a respective foveated luma value, or a respective foveated chroma value associated with each pixel of a plurality of pixels of the foveated image frame.

Aspect 3. The apparatus of any of Aspects 1 or 2, wherein the at least one processor is configured to: apply the first configuration to the blend image frame; and apply the second configuration to the foveated image frame.

Aspect 4. The apparatus of Aspect 3, wherein the at least one processor is configured to apply the first configuration to the blend image frame and the second configuration to the foveated image frame using a shared processing pipeline associated with the peripheral image frame, the blend image frame, and the foveated image frame.

Aspect 5. The apparatus of Aspect 4, wherein the at least one processor is configured to determine the statistics for the peripheral image frame using the shared processing pipeline associated with the peripheral image frame, the blend image frame, and the foveated image frame.

Aspect 6. The apparatus of any of Aspects 1 to 5, wherein the at least one processor is configured to: determine, by a first register associated with the blend image frame, the first starting location within the statistics; and determine, by a second register associated with the foveated image frame, the second starting location within the statistics.

Aspect 7. The apparatus of any of Aspects 1 to 6, wherein the statistics are stored within a shared lookup table (LUT) associated with the peripheral image frame, the blend image frame, and the foveated image frame, and wherein the statistics stored within the shared LUT are associated with the peripheral image frame, the blend image frame, and the foveated image frame.

Aspect 8. The apparatus of Aspect 7, wherein the at least one processor is configured to: update the shared LUT to point to the first starting location within the statistics; and update the shared LUT to point to the second starting location within the statistics.

Aspect 9. The apparatus of any of Aspects 1 to 8, wherein the foveated image frame has a higher resolution than the blend image frame, and wherein the blend image frame has a higher resolution than the peripheral image frame.

### Aspect 10. the Apparatus of Any of Aspects 1 to 9, Wherein the Image Sensor Is a foveated image sensor.

Aspect 11. The apparatus of any of Aspects 1 to 10, wherein the apparatus is an extended reality (XR) device.

Aspect 12. The apparatus of any of Aspects 1 to 11, further comprising the image sensor.

Aspect 13. A method for image processing at a device, the method comprising: obtaining, by an image sensor associated with the device, a peripheral image frame of a scene, a blend image frame, and a foveated image frame, wherein the peripheral image frame comprises the blend image frame and the foveated image frame; determining, based on the peripheral image frame, statistics for the peripheral image frame, wherein the statistics comprise at least one of a respective pixel value, a respective luma value, or a respective chroma value associated with each pixel of a plurality of pixels of the peripheral image frame; determining, based on a first starting location within the statistics, a first configuration for the blend image frame; and determining, based on a second starting location within the statistics, a second configuration for the foveated image frame, wherein the first starting location and the second starting location within the statistics each indicate a respective pixel of the plurality of pixels of the peripheral image frame to start reading the statistics.

Aspect 14. The method of Aspect 13, wherein the first configuration comprises a respective blend pixel value, a respective blend luma value, or a respective blend chroma value associated with each pixel of a plurality of pixels of the blend image frame, and wherein the second configuration comprises a respective foveated pixel value, a respective foveated luma value, or a respective foveated chroma value associated with each pixel of a plurality of pixels of the foveated image frame.

Aspect 15. The method of any of Aspects 13 or 14, further comprising: applying the first configuration to the blend image frame; and applying the second configuration to the foveated image frame.

Aspect 16. The method of Aspect 15, wherein applying the first configuration to the blend image frame and the second configuration to the foveated image frame is performed by a shared processing pipeline associated with the peripheral image frame, the blend image frame, and the foveated image frame.

Aspect 17. The method of Aspect 16, wherein determining the statistics for the peripheral image frame is performed by the shared processing pipeline associated with the peripheral image frame, the blend image frame, and the foveated image frame.

Aspect 18. The method of any of Aspects 13 to 17, further comprising: determining, by a first register associated with the blend image frame, the first starting location within the statistics; and determining, by a second register associated with the foveated image frame, the second starting location within the statistics.

Aspect 19. The method of any of Aspects 13 to 18, wherein the statistics are stored within a shared lookup table (LUT) associated with the peripheral image frame, the blend image frame, and the foveated image frame, and wherein the statistics stored within the shared LUT are associated with the peripheral image frame, the blend image frame, and the foveated image frame.

Aspect 20. The method of Aspect 19, further comprising: updating the shared LUT to point to the first starting location within the statistics; and updating the shared LUT to point to the second starting location within the statistics.

Aspect 21. The method of any of Aspects 13 to 20, wherein the foveated image frame has a higher resolution than the blend image frame, and wherein the blend image frame has a higher resolution than the peripheral image frame.

Aspect 22. The method of any of Aspects 13 to 21, wherein the image sensor is a foveated image sensor.

Aspect 23. The method of any of Aspects 13 to 22, wherein the device is an extended reality (XR) device.

Aspect 24. A non-transitory computer-readable medium having stored thereon instructions that, when executed by at least one processor, cause the at least one processor to perform operations according to any of Aspects 13 to 23.

Aspect 25. An apparatus for image processing, the apparatus including one or more means for performing operations according to any of Aspects 13 to 23.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for image processing, the apparatus comprising:
at least one memory; and
at least one processor coupled to the at least one memory and configured to:
obtain, from an image sensor, a peripheral image frame of a scene, a blend image frame, and a foveated image frame, wherein the peripheral image frame comprises the blend image frame and the foveated image frame;
determine, based on the peripheral image frame, statistics for the peripheral image frame, wherein the statistics comprise at least one of a respective pixel value, a respective luma value, or a respective chroma value associated with each pixel of a plurality of pixels of the peripheral image frame;
determine, based on a first starting location within the statistics, a first configuration for the blend image frame; and
determine, based on a second starting location within the statistics, a second configuration for the foveated image frame, wherein the first starting location and the second starting location within the statistics each indicate a respective pixel of the plurality of pixels of the peripheral image frame to start reading the statistics.

2. The apparatus of claim 1, wherein the first configuration comprises a respective blend pixel value, a respective blend luma value, or a respective blend chroma value associated with each pixel of a plurality of pixels of the blend image frame, and wherein the second configuration comprises a respective foveated pixel value, a respective foveated luma value, or a respective foveated chroma value associated with each pixel of a plurality of pixels of the foveated image frame.

3. The apparatus of claim 1, wherein the at least one processor is configured to:
apply the first configuration to the blend image frame; and
apply the second configuration to the foveated image frame.

4. The apparatus of claim 3, wherein the at least one processor is configured to apply the first configuration to the blend image frame and the second configuration to the foveated image frame using a shared processing pipeline associated with the peripheral image frame, the blend image frame, and the foveated image frame.

5. The apparatus of claim 4, wherein the at least one processor is configured to determine the statistics for the peripheral image frame using the shared processing pipeline associated with the peripheral image frame, the blend image frame, and the foveated image frame.

6. The apparatus of claim 1, wherein the at least one processor is configured to:
determine, by a first register associated with the blend image frame, the first starting location within the statistics; and
determine, by a second register associated with the foveated image frame, the second starting location within the statistics.

7. The apparatus of claim 1, wherein the statistics are stored within a shared lookup table (LUT) associated with the peripheral image frame, the blend image frame, and the foveated image frame, and wherein the statistics stored within the shared LUT are associated with the peripheral image frame, the blend image frame, and the foveated image frame.

8. The apparatus of claim 7, wherein the at least one processor is configured to:
update the shared LUT to point to the first starting location within the statistics; and
update the shared LUT to point to the second starting location within the statistics.

9. The apparatus of claim 1, wherein the foveated image frame has a higher resolution than the blend image frame, and wherein the blend image frame has a higher resolution than the peripheral image frame.

10. The apparatus of claim 1, wherein the image sensor is a foveated image sensor.

11. The apparatus of claim 1, wherein the apparatus is an extended reality (XR) device.

12. The apparatus of claim 1, further comprising the image sensor.

13. A method for image processing at a device, the method comprising:
obtaining, by an image sensor associated with the device, a peripheral image frame of a scene, a blend image frame, and a foveated image frame, wherein the peripheral image frame comprises the blend image frame and the foveated image frame;
determining, based on the peripheral image frame, statistics for the peripheral image frame, wherein the statistics comprise at least one of a respective pixel value, a respective luma value, or a respective chroma value associated with each pixel of a plurality of pixels of the peripheral image frame;
determining, based on a first starting location within the statistics, a first configuration for the blend image frame; and
determining, based on a second starting location within the statistics, a second configuration for the foveated image frame,
wherein the first starting location and the second starting location within the statistics each indicate a respective pixel of the plurality of pixels of the peripheral image frame to start reading the statistics.

14. The method of claim 13, wherein the first configuration comprises a respective blend pixel value, a respective blend luma value, or a respective blend chroma value associated with each pixel of a plurality of pixels of the blend image frame, and wherein the second configuration comprises a respective foveated pixel value, a respective foveated luma value, or a respective foveated chroma value associated with each pixel of a plurality of pixels of the foveated image frame.

15. The method of claim 13, further comprising:
applying the first configuration to the blend image frame; and
applying the second configuration to the foveated image frame.

16. The method of claim 15, wherein applying the first configuration to the blend image frame and the second configuration to the foveated image frame is performed by a shared processing pipeline associated with the peripheral image frame, the blend image frame, and the foveated image frame, and wherein determining the statistics for the peripheral image frame is performed by the shared processing pipeline associated with the peripheral image frame, the blend image frame, and the foveated image frame.

17. The method of claim 13, further comprising:
determining, by a first register associated with the blend image frame, the first starting location within the statistics; and
determining, by a second register associated with the foveated image frame, the second starting location within the statistics.

18. The method of claim 13, wherein the statistics are stored within a shared lookup table (LUT) associated with the peripheral image frame, the blend image frame, and the foveated image frame, and wherein the statistics stored within the shared LUT are associated with the peripheral image frame, the blend image frame, and the foveated image frame.

19. The method of claim 18, further comprising:
updating the shared LUT to point to the first starting location within the statistics; and
updating the shared LUT to point to the second starting location within the statistics.

20. The method of claim 13, wherein the foveated image frame has a higher resolution than the blend image frame, and wherein the blend image frame has a higher resolution that the peripheral image frame.
